(19) United States
(12) Patent Application Publication
(10) Pub. No.: US 2025/0035541 A1
(43) Pub. Date: Jan. 30, 2025

(54) OPTICAL SENSOR DEVICE

(71) Applicant: TIANMA JAPAN, LTD., Kawasaki (JP)

(72) Inventors: Nobuya SEKO, Kawasaki (JP); Koki TAKAHASHI, Kawasaki (JP)

(21) Appl. No.: 18/782,086

(22) Filed: Jul. 24, 2024

(30) Foreign Application Priority Data
Jul. 24, 2023 (JP) 2023-120086

(51) Int. Cl. G01N 21/31

(52) U.S. Cl. CPC G01N 21/31; G01N 2021/3185; G01N 2201/0227; G01N 2201/066; G01N 2201/0683

(57) ABSTRACT

An optical sensor includes a sensing element and an elastic sealing component. The sensing element includes a prism including a hypotenuse face and two leg faces and a sensing film on the hypotenuse face. The sensing film is exposed to a gastight space to include the target substance. A confining wall confining the gastight space has an opening and the opening is covered with the sensing element. The elastic sealing component is located between the sensing element and the opening. The sensing element is fixed by being pressed by the fixture. Light passes through one of the two leg faces and hit the sensing film. Light reflected off the sensing film goes out through the other one of the two leg faces. The photodetector detects light that is reflected off the sensing film and comes out through the other one of the two leg faces.

### CROSS-REFERENCE TO RELATED APPLICATIONS

This non-provisional application claims priority under 35 U.S.C. § 119 (a) on Patent Application No. 2023-120086 filed in Japan on Jul. 24, 2023, the entire content of which is hereby incorporated by reference.

### BACKGROUND

This disclosure relates to an optical sensor device.

Sensor devices for detecting a specific kind of chemical substance and the concentration thereof have been developed; for example, gas sensor devices for detecting leakage of hydrogen gas have been developed. Although a plurality types of hydrogen gas sensors different in sensing scheme are known, common types of sensors are required to operate under high temperature for higher response speed or cleaning effect. Such hydrogen gas sensors required to operate under high temperature are demanded to eliminate the possibility of explosion caused by contact of overcurrent or a spark in an electric circuit with hydrogen.

A scheme for sensing hydrogen gas through an optical approach is known; for example, a photodetection type of gas sensor devices that utilize surface plasmon resonance are known. Meanwhile, a technique that uses a metal layer deposited on a glass substrate as a sensing layer while optically matching the undersurface of the glass substrate and a prism with optical coupling oil. The sensing layer is illuminated through the prism and the light reflected off the sensing layer passes through the prism to be detected by an external photodetector. The prism reduces the light reflected off the glass substrate reaching the photodetector.

### SUMMARY

An aspect of this disclosure is an optical sensor device including: a light source; a sensing element; a photodetector; a fixture; and an elastic sealing component, wherein the sensing element includes: a prism including a hypotenuse face and two leg faces; and a sensing film on the hypotenuse face, the sensing film being configured to sense a target substance, wherein the sensing film is exposed to a gastight space to include the target substance, wherein a confining wall confining the gastight space to include the target substance has an opening and the opening is covered with the sensing element, wherein the elastic sealing component is located between the sensing element and the opening, wherein the sensing element is fixed by being pressed by the fixture in such a strength that the elastic sealing component is elastically deformed, wherein the light source and the photodetector are located outside the gastight space to include the target substance, wherein light from the light source is configured to pass through one of the two leg faces and hit the sensing film, wherein light reflected off the sensing film is configured to go out through the other one of the two leg faces, and wherein the photodetector is configured to detect light that is reflected off the sensing film and comes out through the other one of the two leg faces.

It is to be understood that both the foregoing general description and the following detailed description are exemplary and explanatory and are not restrictive of this disclosure.

### BRIEF DESCRIPTION OF THE DRAWINGS

FIG. 1 is a schematic diagram for illustrating a hydrogen gas measurement method of a hydrogen gas sensor device in an embodiment of this specification.

FIG. 2 schematically illustrates a configuration example of a hydrogen gas sensor device in an embodiment of this specification.

FIG. 3A is a diagram for illustrating the structure of a prism.

FIG. 3B is another diagram for illustrating the structure of a prism.

FIG. 4 is a cross-sectional diagram schematically illustrating a configuration example of a sensing element in an embodiment of this specification.

FIG. 5 is a cross-sectional diagram schematically illustrating another configuration example of a sensing element in an embodiment of this specification.

FIG. 6 illustrates an example of the configuration and usage of a hydrogen gas sensor device in an embodiment of this specification.

FIG. 7A illustrates an example of a gastight structural assembly utilizing a sensing element in a hydrogen gas sensor device and an example of assembling the gastight structural assembly.

FIG. 7B illustrates an example of a gastight structural assembly utilizing a sensing element in a hydrogen gas sensor device and an example of assembling the gastight structural assembly.

FIG. 7C illustrates an example of a gastight structural assembly utilizing a sensing element in a hydrogen gas sensor device and an example of assembling the gastight structural assembly.

FIG. 7D illustrates an example of a gastight structural assembly utilizing a sensing element in a hydrogen gas sensor device and an example of assembling the gastight structural assembly.

FIG. 8A illustrates an example of an assembly including a channel block and a sensing element holder attached to the channel block and an example of assembling the assembly.

FIG. 8B illustrates an example of an assembly including a channel block and a sensing element holder attached to the channel block and an example of assembling the assembly.

FIG. 8C illustrates an example of an assembly including a channel block and a sensing element holder attached to the channel block and an example of assembling the assembly.

FIG. 9A is an exploded perspective diagram illustrating cross-sections of a flange, a sensing element, and a sensing element holder.

FIG. 9B illustrates a state where the flange is pressed and fastened to the sensing element holder with screws.

FIG. 10A is a cross-sectional diagram of a flange, a sensing element, O-rings, and a sensing element holder before they are assembled.

FIG. 10B is a cross-sectional diagram of a state where the flange, the sensing element and the O-rings are mounted on the sensing element holder but the flange has not yet been fastened to the sensing element holder with screws.

FIG. 10C is a cross-sectional diagram of a state where the flange is pressed and fastened to the sensing element holder with screws.

FIG. 11 is a diagram illustrating the region between the prism of the sensing element and the sensing element holder to be sealed by O-rings.

FIG. 12A illustrates an example of the region of a layered film provided on the hypotenuse face of a prism.

FIG. 12B illustrates a state where the sensing element in FIG. 12A is attached on a sensing element holder.

FIG. 12C illustrates a state where a flange for pressing and fixing the sensing element is screwed to the sensing element holder.

FIG. 13A illustrates another structural example of a sensing element.

FIG. 13B illustrates a sensing element and an O-ring attached around the side face of the sensing element.

FIG. 14A is a cross-sectional diagram for illustrating a configuration example in which a sensing element including a conical frustum prism is fixed to be used as a part of a confining wall.

FIG. 14B is another cross-sectional diagram for illustrating a configuration example in which a sensing element including a conical frustum prism is fixed to be used as a part of a confining wall.

FIG. 15A illustrates a state of an O-ring when the O-ring, a sensing element, and a flange are placed in this order onto a sensing element holder but the flange has not yet been fastened with screws.

FIG. 15B illustrates a state where the flange is fastened to the sensing element holder with screws.

FIG. 16A is an exploded perspective diagram illustrating cross-sections of the components of a gastight structure in another embodiment.

FIG. 16B illustrates a state before a fixture is fastened with a screw.

FIG. 16C illustrates a state where the fixture is pressed and fastened to a confining wall with the screw.

FIG. 17A is a cross-sectional diagram of a screw, a fixture, a prism, a transparent plate, an O-ring, and a confining wall before being assembled.

FIG. 17B illustrates a state where the fixture is fastened to the confining wall with the screw.

FIG. 18A is a cross-sectional diagram for illustrating a sealing structure by an O-ring.

FIG. 18B is a cross-sectional diagram for illustrating a sealing structure by an O-ring.

FIG. 19 illustrates an example of the region of the layered film provided on the hypotenuse face of a prism.

FIG. 20A schematically illustrates the gastight structure in Embodiment 1.

FIG. 20B schematically illustrates the gastight structure in Embodiment 2.

FIG. 20C schematically illustrates the gastight structure in Embodiment 3.

### EMBODIMENTS

Hereinafter, embodiments of this disclosure will be described with reference to the accompanying drawings. The elements in each drawing are changed in size or scale as appropriate to be well recognized in the drawing. The hatches in the drawings are to distinguish the elements and are not necessarily to represent cross-sections. It should be noted that the embodiments are merely examples to implement this disclosure and not to limit the technical scope of this disclosure.

The embodiments of this specification are about a gas sensor device as an example of an optical chemical sensor device. The gas sensor devices in the embodiments detect a target substance by measuring the variation in optical characteristics of a sensing film caused by contact with the target substance.

A gas sensing element including a single-layer or multilayer gas sensing film deposited on a transparent substrate including a prism can be used in apparatuses for generating, refining, or mixing a gas. In order to use such a gas sensing element in these apparatuses, demanded is to prevent the gas to be tested (test object) at a pressure higher than the ambient pressure from leaking to the external or the ambient air from entering the space including the gas to be tested at a pressure lower than the ambient pressure. To conduct a test, the gas sensing film of the gas sensing element needs to be located in the gas to be tested. However, components to be electrified, such as a light source and a photodetector, are disposed outside the atmosphere of the gas to be tested for safety purposes. Accordingly, the light for measurement needs to be transmitted through a gastight confining wall.

An aspect of this disclosure uses a sensing element including a prism as a part of the confining wall of a gastight space. This configuration enables the sensing film exposed to the test object to be illuminated with measurement light from outside the gastight space, while achieving compactness of the device.

### Embodiment 1

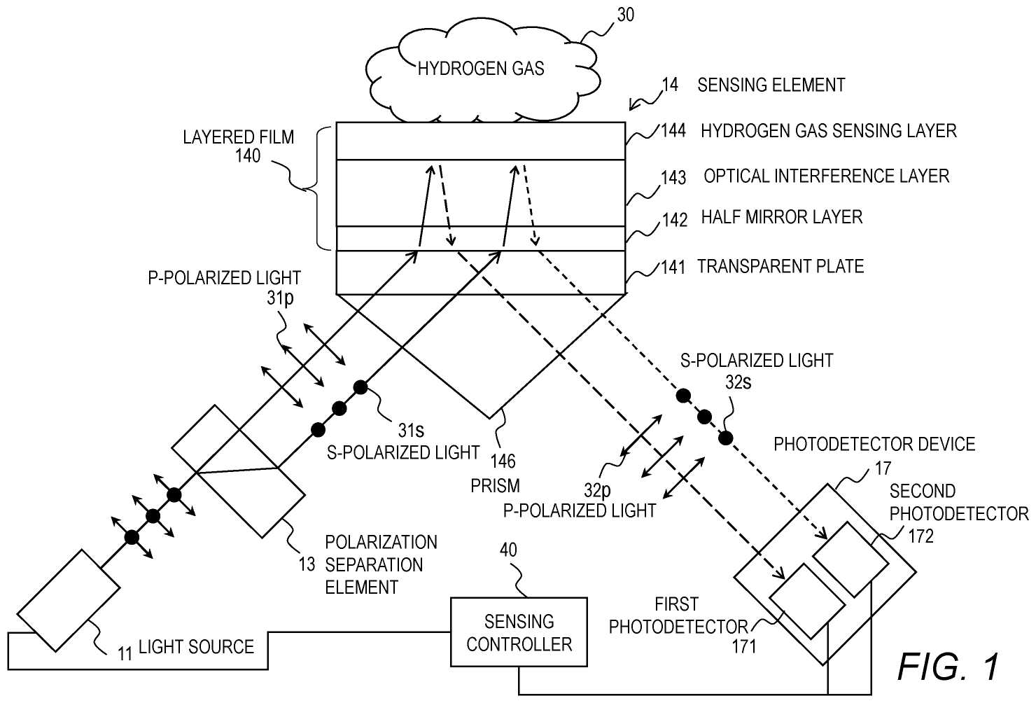

FIG. 1 is a schematic diagram for illustrating a hydrogen gas measurement method of a hydrogen gas sensor device in an embodiment of this specification. As will be described later, a hydrogen gas sensing element in an embodiment of this specification is fixed to cover an opening of a confining wall for confining hydrogen gas. The sensing element includes a sensing film deposited on a transparent substrate. The transparent substrate includes a prism. The sensing element functions as a part of a gastight structure (confining wall) separating hydrogen atmosphere from the ambient air and the gap between the transparent substrate and the other part of the confining wall is sealed by a sealing structure.

The hydrogen gas sensor device is an example of an optical chemical sensor device and the target substance to be detected is hydrogen gas. The hydrogen gas sensor device can detect the concentration of hydrogen gas. The lines with an arrow in FIG. 1 represent optical paths. The hydrogen gas sensor device is based on an oblique-incidence optical system.

The hydrogen gas sensor device includes a light source 11, a polarization separation element (polarization separator) 13, a sensing element 14, a photodetector device 17, and a sensing controller 40. The illumination optical system includes the light source 11 and the polarization separation element 13. The sensing controller 40 controls the other components of the hydrogen gas sensor device, measures the intensity of light reflected off the sensing element 14, and calculates a measurement value based on the intensity of the reflected light.

The sensing element 14 includes a transparent plate 141 and a layered film 140 provided on the transparent plate 141. The layered film 140 is a layered hydrogen gas sensing film and includes a half mirror layer 142, an optical interference layer 143, and a hydrogen gas sensing layer 144 deposited in this order on the transparent plate 141. This configuration of the layered film 140 is an example; the material to be used is selected as appropriate and the number of layers is determined as appropriate from one or more.

A prism 146 is attached on the other side of the transparent plate 141 opposite the layered film 140 and optically coupled to the transparent plate 141 by not-shown optical coupling oil. The prism 146 reduces the reflection of incident light off the underside of the transparent plate 141 on which the layered film 140 is not provided traveling toward the photodetector.

The surface of the hydrogen gas sensing layer 144 is in contact with hydrogen gas 30 or the target substance. The hydrogen gas sensor device detects hydrogen gas by measuring the variation in optical characteristics of the sensing element 14 caused by the hydrogen gas 30. More specifically, the hydrogen gas sensor device detects the concentration of hydrogen gas by measuring the difference in reflectance of the layered film 140 for p-polarized light and s-polarized light depending on the concentration of hydrogen gas.

In the configuration of FIG. 1, the hydrogen gas sensor device obliquely illuminates the layered film 140 with light through the prism 146 and the underside of the transparent plate 141 on which the layered film 140 for detecting the hydrogen gas 30 is not provided. The photodetector device 17 detects the reflected p-polarized light 32p and the reflected s-polarized light 32s and the sensing controller 40 determines the hydrogen concentration based on the difference between their intensities. The difference between their intensities can be expressed by a function using a difference or a ratio, as will be described later.

The layered film 140 has a structure such that the light reflected off the interface between the half mirror layer 142 and the transparent plate 141 and the light that has entered the layered film 140 and is reflected off the hydrogen gas sensing layer 144 interfere with each other. For simplicity of illustration, the light reflected off the interface between the half mirror layer 142 and the transparent plate 141 is not shown in FIG. 1. The same applies to the other drawings. The hydrogen gas sensor device makes the light emitted from the light source 11 obliquely incident on the surface of the layered film of the sensing element 14. An oblique-incidence optical system usually provides different reflectance values for p-polarized light and s-polarized light. Moreover, a layered film like the one in this embodiment imposes different interference conditions onto p-polarized light and s-polarized light.

The behaviors of reflection of p-polarized light and s-polarized light off the layered film 140 providing the above-described conditions appear in the reflectance of the layered film 140 for p-polarized light and s-polarized light. What are actually detected by the photodetectors 171 and 172 are the intensities of the reflected p-polarized light 32p and the reflected s-polarized light 32s. Since the incident p-polarized light 31p and the incident s-polarized light 31s are acquired by separating light from a single light source 11 with the polarization separation element 13, the proportions of their intensities are fixed. Accordingly, the reflectance for p-polarized light and s-polarized light can be obtained in the form of a ratio from the intensity ratio of the reflected p-polarized light 32p to the reflected s-polarized light 32s. Using the intensity ratio of the reflected p-polarized light 32p to the reflected s-polarized light 32s eliminates the effect of possible variation in intensity of light emitted from the light source.

The light source 11 emits light that reaches the layered film 140 provided on the transparent plate 141 through the prism 146. The light source 11 can be a monochromatic light source for emitting single-wavelength light, such as a semiconductor laser, an LED, or a gas laser.

The polarization separation element 13 is disposed on the optical path between the light source 11 and the sensing element 14. The polarization separation element 13 separates the light from the light source 11 into p-polarized light 31p and s-polarized light 31s. The p-polarized light 31p and s-polarized light 31s hit the sensing element 14. The p-polarized light 31p and the s-polarized light 31s travel along different optical paths and hit different points of the sensing element 14.

The p-polarized light 31p and s-polarized light 31s separated by the polarization separation element 13 travel along different optical paths, pass through the prism 146, and reach the underside of the transparent plate 141 on which the layered film 140 is not provided. They hit the underside of the transparent plate 141 obliquely with respect to the layering direction of the layered film 140 (the direction normal to the transparent plate 141). An example of the incident angle is 45°.

The p-polarized light 31p and s-polarized light 31s that have entered the transparent plate 141 partially reflect off the interface between the transparent plate 141 and the half mirror layer 142. The remaining light passes through the half mirror layer 142 and the optical interference layer 143, reflects off the hydrogen gas sensing layer 144, passes through the optical interference layer 143 and the half mirror layer 142 again in the reverse direction, and interferes with the aforementioned light reflecting off the interface between the transparent plate 141 and the half mirror layer 142.

In this regard, the interference conditions for the p-polarized light and the s-polarized light are different. For the wavelength of light from the light source 11 to be used for sensing, the layered film 140 is configured so that the interference with either p-polarized light or s-polarized light will generate a condition close to its resonance condition. The intensity of the reflected polarization component provided with a condition close to the resonant condition will take an extremely small value because of the interference. On the other hand, the intensity of the reflected polarization component provided with a condition off the resonant condition will take a relatively large value.

The p-polarized light 32p and the s-polarized light 32s reflected off the sensing element 14 travel along different optical paths. The reflected p-polarized light 32p and the reflected s-polarized light 32s are detected by a first photodetector 171 and a second photodetector 172, respectively. The first photodetector 171 and the second photodetector 172 are components of the photodetector device 17 and they are disposed at different locations. The first photodetector 171 is located on the optical path of the reflected p-polarized light 32p to detect the intensity of the reflected p-polarized light 32p and the second photodetector 172 is located on the optical path of the reflected s-polarized light 32s to detect the intensity of the reflected s-polarized light 32s.

The sensing controller 40 controls light emission of the light source 11 and further, receives detection signals from the first photodetector 171 and the second photodetector 172. The sensing controller 40 receives signals representing the intensities of the reflected p-polarized light 32p and the reflected s-polarized light 32s from the first photodetector 171 and the second photodetector 172. The sensing controller 40 calculates the concentration of the hydrogen gas based on the result of comparison of those signals.

For example, the sensing controller 40 determines the hydrogen concentration from the intensities of the reflected p-polarized light 32p and the reflected s-polarized light 32s, using a predefined function (including a look-up table). The function can include the ratio of the intensity of p-polarized light to the intensity of s-polarized light as a variable. If the proportion of the p-polarization component to the s-polarization component in the illumination system is kept constant, the variation in intensity of light emitted from the light source 11 can be ignored by using the ratio of the intensity of reflected p-polarized light to the intensity of reflected s-polarized light. The sensing element 14 includes a layered film 140 consisting of a half mirror layer 142, an optical interference layer 143, and a hydrogen gas sensing layer 144 deposited in this order on the transparent plate 141, as illustrated in FIG. 1. Each of these layers can be composed of a single layer or a plurality of layers. The hydrogen gas sensing layer 144 is a chemical sensing layer, which is made of material appropriate for the target substance to be detected.

The hydrogen gas sensing layer 144 varies in its optical characteristics such as the refractive index and the absorption coefficient in response to contact with hydrogen gas. The hydrogen gas sensor device measures the variation in intensity of reflected p-polarized light and s-polarized light caused by the variation in optical characteristics of the hydrogen gas sensing layer 144 to detect hydrogen gas.

The optical interference layer 143 is an intermediate layer having a structure to make the light that enters the layered film 140 out of the light illuminating the layered film 140 and reflects off the hydrogen gas sensing layer 144 interfere with the light that reflects off the interface between the transparent plate 141 and the half mirror layer 142. For example, the value of the sum of the product of the thickness and the refractive index of the half mirror layer 142 and the product of the thickness and the refractive index of the optical interference layer 143 is larger than approximately ¼ of the wavelength of the illumination light.

The half mirror layer 142 reflects some part of the incident light and transmits some other part. The half mirror layer 142 has a thickness that allows the light illuminating the layered film 140 to enter the inside of the layered film 140. For example, the half mirror layer 142 can have a thickness more than 0 nm and not more than 30 nm. The hydrogen gas sensing layer 144 has a thickness enough to reflect the light that enters the inside of the layered film 140; for example, it can have a thickness not less than 20 nm. A thicker hydrogen gas sensing layer 144 can reduce the effect of variation of the surface condition of the sensing layer, enabling more stable detection of the target substance.

For the material for the hydrogen gas sensing layer 144, any material can be employed that varies in its optical characteristic such as refractive index or absorption coefficient by reacting to hydrogen gas. An example of such material is palladium (Pd) that significantly varies in optical characteristics in response to contact with hydrogen gas. A palladium-containing thin film can be employed as the hydrogen gas sensing layer 144. Such a hydrogen gas sensing layer 144 contributes to provision of a hydrogen gas sensor operable at room temperature and having high sensitivity because palladium has characteristics to occlude and discharge hydrogen gas under room temperature.

For the material for the optical interference layer 143, common transparent oxides, transparent nitrides, and transparent fluorides such as silicon dioxide (SiO₂), zinc oxide (ZnO), magnesium oxide (MgO), titanium oxide (TiO₂), aluminum nitride (AlN), silicon nitride (Si₃N₄), and magnesium fluoride (MgF₂) can be listed. The optical interference layer 143 can be made of a dielectric having high transmissivity to the wavelength of light emitted from the light source 11.

For the material for the half mirror layer 142, common metallic materials including metals such as silver (Ag), aluminum (Al), gold (Au), copper (Cu), and tantalum (Ta) and alloys containing such metals can be listed. The material for the half mirror layer 142 can have a high reflectance for the wavelength of light emitted from the light source 11. The transparent plate 141 can be a glass substrate having a thickness of approximately 0.5 mm (500 μm), for example.

As described above, the hydrogen gas sensor device the layered film 140 from its underside with light and detects the p-polarized light and s-polarized light reflected off the layered film 140. The hydrogen gas sensor device detects hydrogen gas by detecting the variation in optical characteristics of the hydrogen gas sensing layer 144 caused by contact with hydrogen gas 30 in the form of optical signals representing the variation in intensity of p-polarized light and s-polarized light reflected off the layered film 140.

When hydrogen gas contacts the hydrogen gas sensing layer 144, the optical characteristics of the hydrogen gas sensing layer 144 vary, so that the interference condition of the layered film 140 varies. The interference condition varies differently for p-polarized light and s-polarized light; especially, the reflectance for the polarization component provided with a condition close to the resonance condition varies significantly because of the variation in optical characteristics of the hydrogen gas sensing layer 144 caused by contact with hydrogen. As a result, the intensity ratio of the reflected p-polarized light to the reflected s-polarized light varies significantly. As understood from this description, the optical signal can be much enhanced because of the optical interference occurring in the layered film 140, so that hydrogen gas can be detected with high sensitivity. The same applies to other target substances and layered films including a chemical sensing layer therefor.

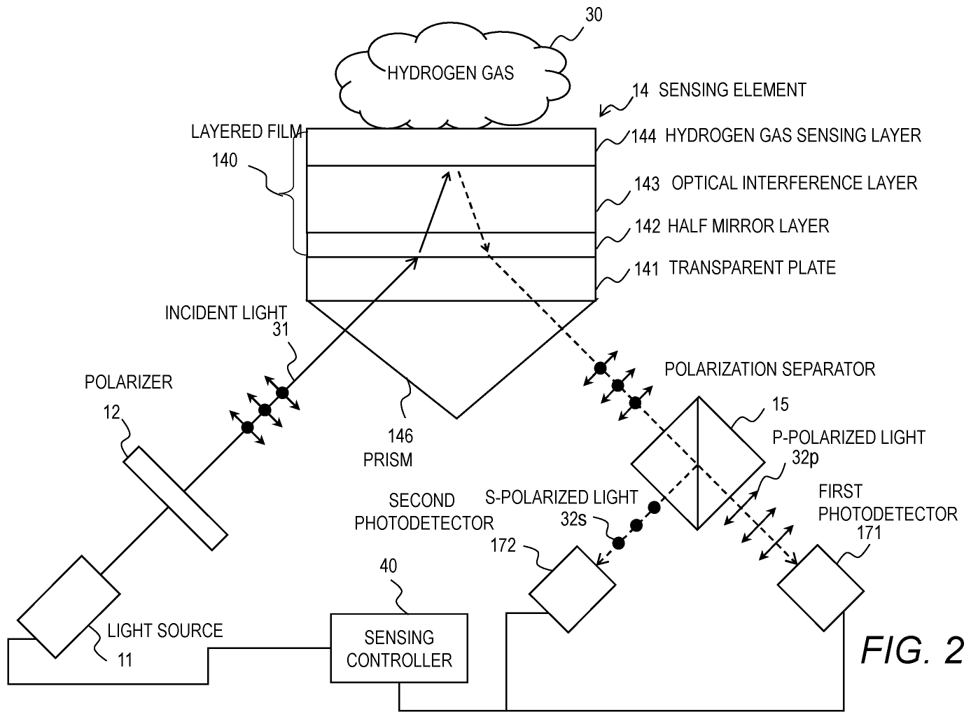

FIG. 2 schematically illustrates a configuration example of a hydrogen gas sensor device in an embodiment of this specification. The following mainly describes differences from the configuration example in FIG. 1. Like the configuration example in FIG. 1, this hydrogen gas sensor device is based on an oblique-incidence optical system; it obliquely illuminates a sensing element 14 with light through a prism 146 and the underside of a transparent plate 141 on which a layered film 140 for sensing hydrogen gas is not provided to detect hydrogen gas. The sensing element 14 has the same structure as the one in the configuration example in FIG. 1.

The illumination optical system includes a light source 11 and a polarizer 12. The polarizer 12 is disposed on the optical path of the incident light 31 between the light source 11 and the sensing element 14. The polarizer 12 transmits light polarized linearly in a specific direction and attenuates light polarized in the other directions. The polarizer 12 can be adjusted in advance so that the difference in intensity between reflected p-polarized light and reflected s-polarized light will fall within a specific range when the hydrogen concentration is within the measurement limit. For example, the rotation angle of the polarizer 12 can be adjusted so that the intensities of reflected p-polarized light and reflected s-polarized light will be substantially equal when hydrogen gas does not exist. Such appropriate adjustment of the rotation angle of the polarizer 12 increases the accuracy in measurement, although the polarizer 12 is optional.

Further, a polarization separator 15 is disposed on the optical path between the sensing element 14 and a photodetector device. Although FIG. 2 does not show a frame indicating the photodetector device 17 shown in FIG. 1 for simplicity of illustration, the photodetector device 17 in FIG. 2 includes a first photodetector 171 and a second photodetector 172, like the photodetector device 17 in the configuration example in FIG. 1. The polarization separator 15 separates p-polarized light 32p and s-polarized light 32s from the light reflected off the sensing element 14. The p-polarized light 32p and s-polarized light 32s from the polarization separator 15 travel along different optical paths.

The linearly polarized light 31 transmitted through the polarizer 12 passes through the prism 146 and hits the layered film 140 of the sensing element 14 with an intensity ratio of the p-polarized component to the s-polarized component in accordance with the polarization angle. As described above, the linearly polarized light 31 hits the layered film 140 at an angle inclined with respect to the normal to the layered film 140. Unlike in FIG. 1, the incident light is not separated to p-polarized light and s-polarized light and the linearly polarized light 31 hits one point. For this reason, the effect of the difference in characteristics within the plane of the layered film 140 can be avoided.

The p-polarized light (component) and the s-polarized light (component) in the incident light are provided with different interference conditions from the layered film 140. Further, the optical characteristics of the hydrogen gas sensing layer 144 vary in response to the hydrogen gas 30. Accordingly, the reflectance of the hydrogen gas sensing layer 144 and the interference conditions of the layered film 140 for p-polarized light and s-polarized light vary. As a result, the intensity ratio of p-polarized light to s-polarized light in the light reflected off the layered film 140 varies significantly.

The light reflected off the layered film 140 enters the polarization separator 15 and is separated into p-polarized light 32p and s-polarized light 32s. These travel along different optical paths. The first photodetector 171 receives the p-polarized light 32p and outputs its intensity to the sensing controller 40. The second photodetector 172 receives the s-polarized light 32s and outputs its intensity to the sensing controller 40. This configuration of separating the light reflected off the sensing element 14 into p-polarized light and s-polarized light, detecting their intensities, and using their ratio can eliminate the effect of the variation in intensity of light from the light source.

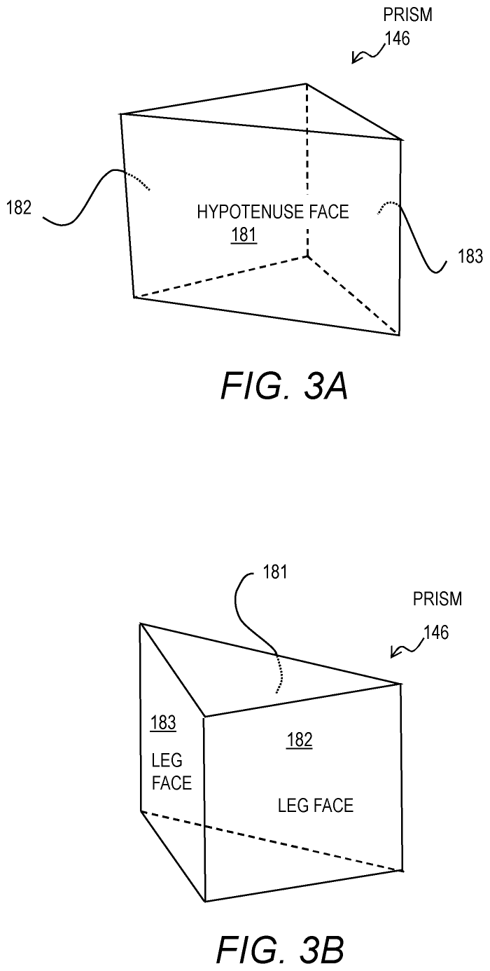

FIGS. 3A and 3B are diagrams for illustrating the structure of the prism 146. The prism 146 is a right-angle prism having a shape of a triangular prism. The structure of the prism is not limited to the one illustrated in FIGS. 3A and 3B. Furthermore, the angle between the incident light on the prism 146 and the reflected light going out from the prism 146 is not limited to 90º.

In the structural example of the prism 146 in FIGS. 3A and 3B, the prism 146 has a hypotenuse face 181 and two leg faces 182 and 183 sandwiching the hypotenuse face 181. The hypotenuse face 181 is continued to the two leg faces 182 and 183. The angle between the leg faces 182 and 183 is a right angle and the angles between the leg face 182 and the hypotenuse face 181 and between the leg face 183 and the hypotenuse face 181 are 45°. The transparent plate 141 with the layered film 140 is placed on the hypotenuse face 181. The other two faces defined by the hypotenuse face 181 and the leg faces 182 and 183 are the top base and the bottom base of the triangular prism.

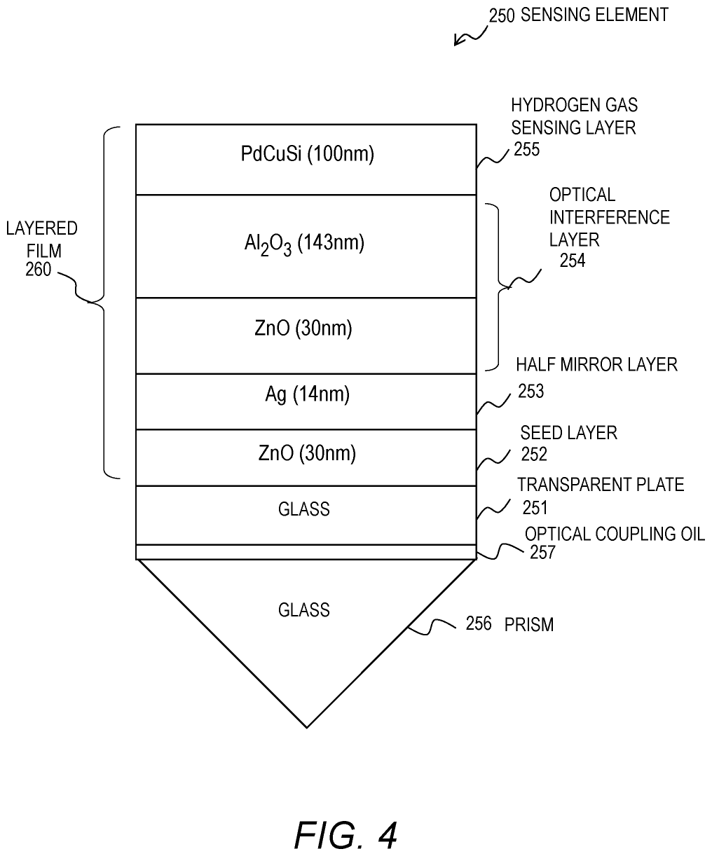

FIG. 4 is a cross-sectional diagram schematically illustrating a configuration example of a sensing element 250 in an embodiment of this specification. The sensing element 250 includes a layered film 260 for sensing hydrogen gas on a transparent plate 251 made of glass. The layered film 260 consists of a seed layer 252, a half mirror layer 253, an optical interference layer 254, and a hydrogen gas sensing layer 255. The seed layer 252, the half mirror layer 253, the optical interference layer 254, and the hydrogen gas sensing layer 255 are deposited in this order on the transparent plate 251.

The half mirror layer 253 is an Ag thin film of 14 nm in thickness. The optical interference layer 254 is a layered film consisting of a ZnO thin film of 30 nm in thickness and an Al₂O₃ thin film of 143 nm in thickness. The hydrogen gas sensing layer 255 is a PdCuSi alloy thin film of 100 nm in thickness. The seed layer 252 is a ZnO thin film of 30 nm in thickness. The seed layer 252 maintains the sticking force to the transparent plate 251.

A prism 256 is provided on the underside of the transparent plate 251 on which the layered film 260 is not provided and the prism 256 is optically coupled to the transparent plate 251 with optical coupling oil 257. The prism 256 reduces the effect of the reflection of light off the underside of the transparent plate 251. The optical coupling oil 257 reduces the reflection of light off the interface between the transparent plate 251 and the prism 256.

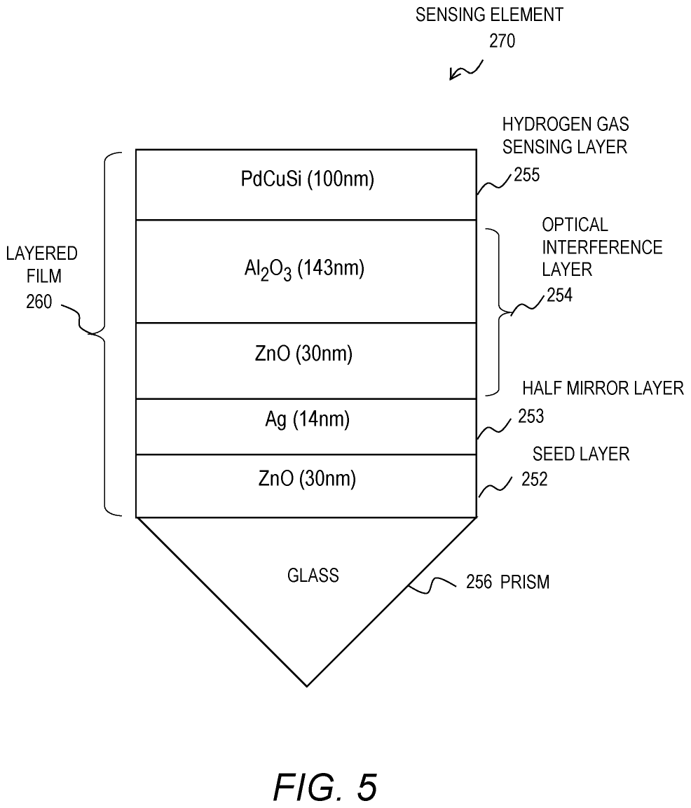

FIG. 5 is a cross-sectional diagram schematically illustrating a configuration example of a sensing element 270 in an embodiment of this specification. The sensing element 270 has a structure such that the transparent plate 251 and the optical coupling oil 257 are excluded from the sensing element 250 in FIG. 4. This example is produced by directly depositing the layered film on the hypotenuse face of the prism 256 without using a thin glass plate. No thin glass plate in the region to receive pressure for fixing the sensing element 270 increases the mechanical strength of the sensing element. Furthermore, no need of optical coupling oil eliminates contamination to the gas to be tested. On the other hand, the sensing element 250 produced by depositing layers on a transparent plate 251 can be manufactured more easily and efficiently than the sensing element 270 produced by depositing layers on a prism 256 because holding the substrate during the layer deposition is easy.

In the gas sensor devices in the embodiments of this specification to be described in the following, the sensing element 14 can have the configuration described with reference to FIG. 4 or 5 or still another configuration. For example, the seed layer can be excluded. The hydrogen gas sensing layer 255 can be provided with a protection layer for protecting the surface of the hydrogen gas sensing layer 255 and/or expediting the reaction with its catalytic effect. Each layer can be composed of a plurality of layers, instead of a single layer. The prism 256 can be provided with anti-reflection film on its leg faces.

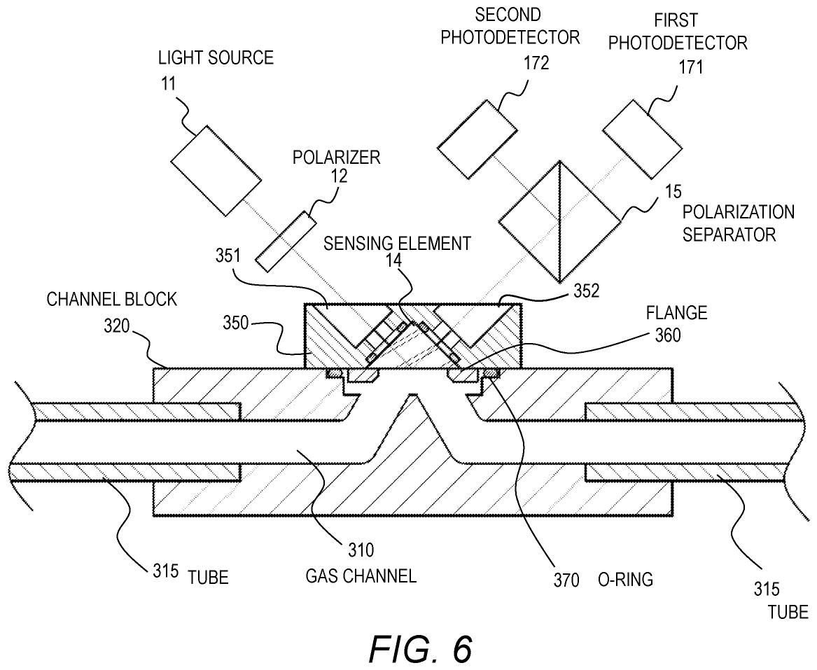

FIG. 6 illustrates an example of the configuration and usage of a hydrogen gas sensor device in an embodiment of this specification. FIG. 6 depicts a state where the hydrogen gas sensor device is inserted in the middle of a tube 315 for transmitting a gas to be tested in order to measure the hydrogen concentration in the gas flowing through a gas channel 310 of the hydrogen gas sensor device. The gas to be tested is a gas that contains or may contain hydrogen and the space in the gas channel 310 can be pressurized or depressurized depending on the application. In other words, the pressure in the gas channel 310 can be equal to, or higher or lower than the ambient pressure. A gas that contains or may contain hydrogen gas flows through the gas channel 310. The hydrogen gas sensor device has the optical system in the configuration example described with reference to FIG. 2, although some components in the configuration example in FIG. 2 may be omitted and some components not shown in FIG. 2 may be added.

The gas channel 310 is defined by a confining wall formed of a channel block 320 and a sensing element holder 350 to which the sensing element 14 is attached; the confining wall separates the space of the gas channel 310 and the gas flowing therethrough from the external. The two components forming the confining wall, the channel block 320 and the sensing element holder 350, are provided with reference signs in FIG. 6. The channel block 320 and the sensing element holder 350 can be made of metal or resin.

The sensing element holder 350 has a plate-like shape having a hollow and the sensing element 14 is embedded in the hollow. The sensing element 14 is pressed and fixed to the sensing element holder 350 by a flange 360. The flange 360 is fastened to the sensing element holder 350 with screws, for example. The screws in this specification include bolts. The layered film 140 of the sensing element 14 is exposed within the gas channel 310 through a hole in the flange 360. The hole is a through hole. The light from the light source 11 illuminates the sensing element 14 through a hole 351 in the sensing element holder 350. The light reflected off the sensing element 14 enters the polarization separator 15 through another hole 352 in the sensing element holder 350.

The sensing element holder 350 is fastened to the channel block 320 with screws, for example. The flange 360 is fastened to the face of the sensing element holder 350 facing the channel block 320. An O-ring 370 is interposed between the sensing element holder 350 and the channel block 320. The O-ring 370 is surrounding the flange 360. The O-ring 370 seals the gap between the channel block 320 and the sensing element holder 350 to prevent leakage of the gas from the gas channel 310 or inflow of the ambient air into the gas channel 310. All the O-rings described in the following are examples of elastic sealing components.

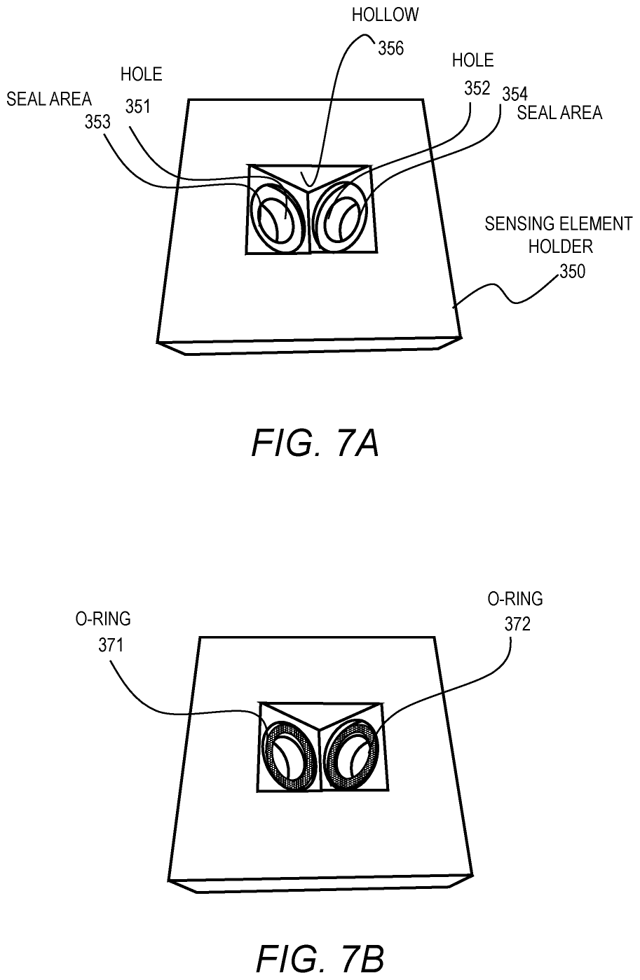

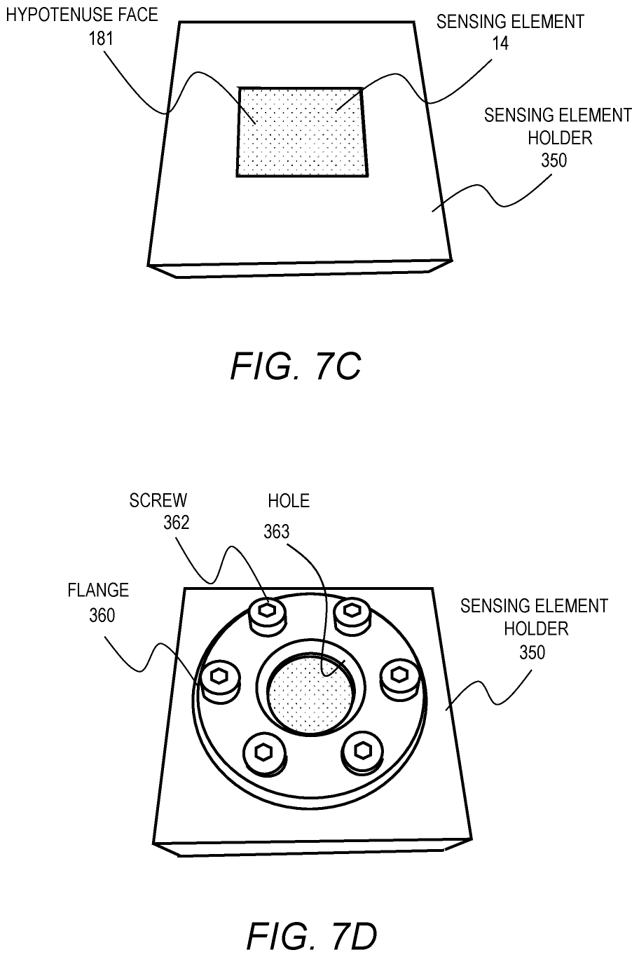

FIGS. 7A to 7D illustrate an example of a gastight structural assembly utilizing the sensing element 14 in a hydrogen gas sensor device and an example of assembling the gastight structural assembly. FIG. 7A illustrates a structural example of a sensing element holder 350. FIG. 7A is a diagram when the sensing element holder 350 is viewed from the side on which the channel block 320 is to be located.

The sensing element holder 350 has a hollow in the face to face the channel block 320. The sensing element 14 is embedded into the hollow 356. Holes 351 and 352 to be parts of the optical path of the light for measurement are opened in inner faces of the hollow 356. The hollow 356 is continued to the outside of the channel through the holes 351 and 352. The faces having openings of the holes 351 and 352 are to be parallel to the leg faces 182 and 183 of the prism 146 and oblique to the part of the confining wall facing the holes 351 and 352. The other two substantially triangular inner faces between the faces having openings are perpendicular to the part of the confining wall to accord with the shape of the other faces of the prism 146.

The sensing element 14 is placed in the hollow 356 so that the leg faces 182 and 183 of the sensing element 14 cover the holes 351 and 352, respectively. The inner faces of the hollow 356 have recessed areas (steps) 353 and 354 around the openings of the holes 351 and 352. The areas 353 and 354 are seal areas to be sealed by O-rings. As described above, the hollow 356 includes a space shaped like a triangular prism for accommodating the sensing element 14 with a prism and annular spaces for accommodating O-rings. The holes 351 and 352, the hollow 356, and the seal areas 353 and 354 can be formed by machining a thick metal plate.

FIG. 7B illustrates the sensing element holder 350 and O-rings 371 and 372 placed in the hollow 356. The O-rings 371 and 372 are placed on the seal area 353 around the hole 351 and the seal area 354 around the hole 352, respectively. For example, the toric O-rings 371 and 372 have inner diameters (the diameters of the central holes) equal to or larger than the diameters of the holes 351 and 352, outer diameters equal to or smaller than the outer diameters of the seal areas 353 and 354, and cross-section diameters (thicknesses) larger than the depths of the seal areas 353 and 354. The differences of the cross-section diameters from the depth of the seal areas 353 and 354 are in the range where the amounts of compression (squeezes) of the O-rings 371 and 372 can provide effective sealing characteristics.

The cross-section of the elastic ring for sealing does not need to be a circle of a common O-ring but can be an oval or a quadrangle. The same applies to the other embodiments.

FIG. 7C illustrates a configuration example of the assembly of the sensing element holder 350 and the sensing element 14 attached to the sensing element holder 350. The sensing element 14 is embedded in the hollow 356 formed in one main face of a plate-like sensing element holder 350. This main face is to face the channel block 320 and the gas channel 310. The leg faces 182 and 183 (these reference signs are not shown in FIG. 7C) of the sensing element 14 are opposed to inner faces of the hollow 356 and parts of them are exposed in the holes 351 and 352. The leg faces 182 and 183 are in contact with the O-rings 371 and 372, respectively. The hypotenuse face 181 is exposed from the face of the sensing element holder 350 that is to face the channel block 320. The region of the hypotenuse face 181 exposed from the hollow 356 is exposed to hydrogen gas in the gas channel 310.

FIG. 7D illustrates a configuration example of the assembly further including a flange 360 in addition to the sensing element 14 and the sensing element holder 350. The flange 360 is an annular plate having circular outer and inner ends and has a hole 363 at the center. The flange 360 is fastened to the sensing element holder 350 with a plurality of screws 362. The screws 362 extend through mounting holes of the flange 360 to be inserted into screw holes of the sensing element holder 350. The screw holes of the sensing element holder 350 are not through-holes. FIGS. 7A to 7C do not show the screw holes of the sensing element holder 350 to avoid complexity of the drawings. In FIG. 7D, one of the screws is provided with a reference sign 362 by way of example. The flange 360 covers a part of the hypotenuse face 181 and the entire or a partial region of the layered film 140 (not shown in FIG. 7D) of the sensing element 14 is exposed from the hole 363.

The flange 360 is a fixture to press and fix the sensing element 14 to the sensing element holder 350. The hollow 356 is formed so that the hypotenuse face 181 of the prism 146 will be substantially flush with the sensing element holder 350 if the sensing element 14 is embedded in the hollow 356 without O-rings 371 and 372. When the sensing element 14 is pressed by the flange 360, the O-rings 371 and 372 in contact with the leg faces 182 and 183 and the seal areas 353 and 354 of the sensing element holder 350 are compressed. The O-rings 371 and 372 appropriately seal the gap between the leg face 182 and the seal area 353 and the gap between the leg face 183 and the seal area 354 with their amounts of compression when the sensing element 14 is accommodated in a predetermined place in the hollow 356.

An elastic sealing component like an O-ring seals the gap between seal areas by being compressed by another component so that its cross-section is flattened. The expression “being flattened” indicates a phenomenon that the cross-section of the elastic sealing component is elastically deformed by pressure so that the size in the direction of press decreases and the sizes in the other directions increase. The fixture presses the sensing element so that the elastic sealing component is compressed and elastically deformed to fix the sensing element.

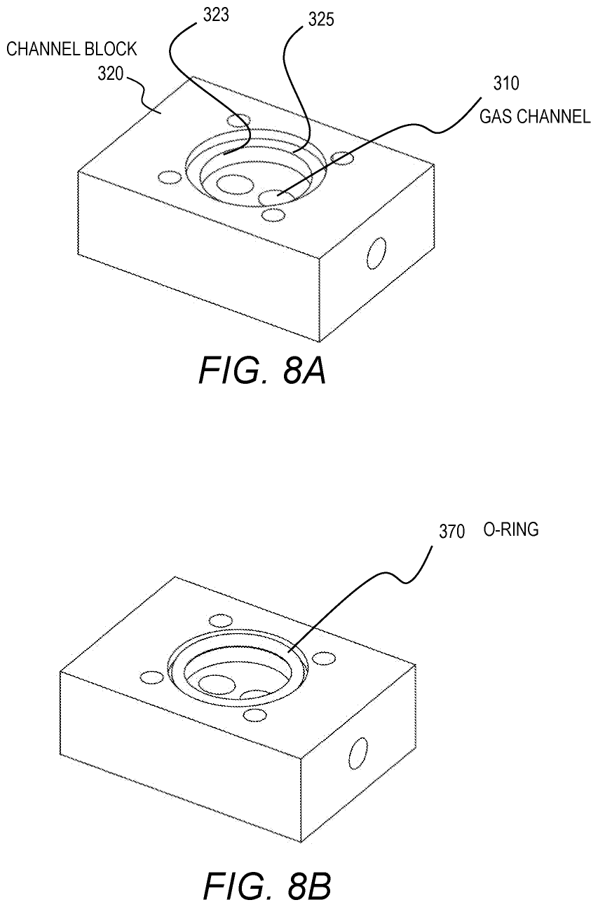

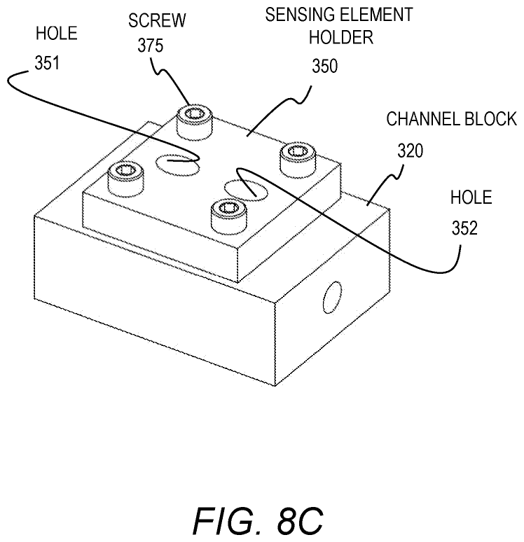

FIGS. 8A, 8B, and 8C illustrate an example of an assembly including a channel block 320 and a sensing element holder 350 attached to the channel block 320 and an example of assembling the assembly. FIG. 8A illustrates a configuration example of a channel block 320 and FIG. 8B illustrates a configuration example of the channel block 320 and an O-ring 370 placed on the channel block 320.

The channel block 320 has a hollow 323. The bottom of the hollow 323 has holes to be parts of the gas channel 310. The flange 360 described with reference to FIG. 7D is embedded in the hollow 323. The channel block 320 has a recessed area (step) 325 surrounding the opening of the hollow 323. The O-ring 370 is placed on the recessed area 325 surrounding the opening of the hollow 323. This recessed area 325 is a seal area; the O-ring 370 is placed on the seal area 325. For example, the toric O-ring 370 has an inner diameter equal to or larger than the inner diameter of the seal area 325, an outer diameter equal to or smaller than the outer diameter of the seal area 325, and a cross-section diameter (thickness) larger than the depth of the seal area 325. The difference of the cross-section diameter from the depth of the seal area 325 is in the range where the amount of compression of the O-ring 370 can provide effective sealing characteristics. The cross-section of the elastic ring for sealing does not need to be a circle of a common O-ring but can be an oval or a quadrangle.

FIG. 8C illustrates a configuration example of an assembly including the channel block 320 and the sensing element holder 350 fixed to the channel block 320. The assembly in FIG. 7D including the sensing element holder 350, the sensing element 14, and the flange 360 is mounted onto the channel block 320 by inserting the flange 360 into the hollow 323. The sensing element holder 350 is fixed to the channel block 320 with a plurality of screws 375. The screws 375 extend through mounting holes of the sensing element holder 350 to be inserted into screw holes of the channel block 320. The screw holes are not through-holes for the gas channel and the screw holes do not penetrate the gas channel. In FIG. 8C, one of the screws is provided with a reference sign 375 by way of example.

The inner diameter of the O-ring 370 is larger than the outer diameter of the flange 360; the flange 360 is placed in the hole of the O-ring 370. The O-ring 370 is compressed by the sensing element holder 350 to appropriately seal the gap between the sensing element holder 350 and the channel block 320, attaining a structure corresponding to the structure illustrated in the cross-sectional diagram of FIG. 6.

As described above, the flange 360 not shown in FIGS. 8A to 8C is located in the hollow 323 of the channel block 320 and at least a part of the layered film 140 on the hypotenuse face 181 of the sensing element 14 is exposed to the gas channel 310 through the hole 363 of the flange 360 (see FIG. 7D). The light from the light source 11 enters the hole 351 and the light reflected off the sensing element 14 exits through the hole 352.

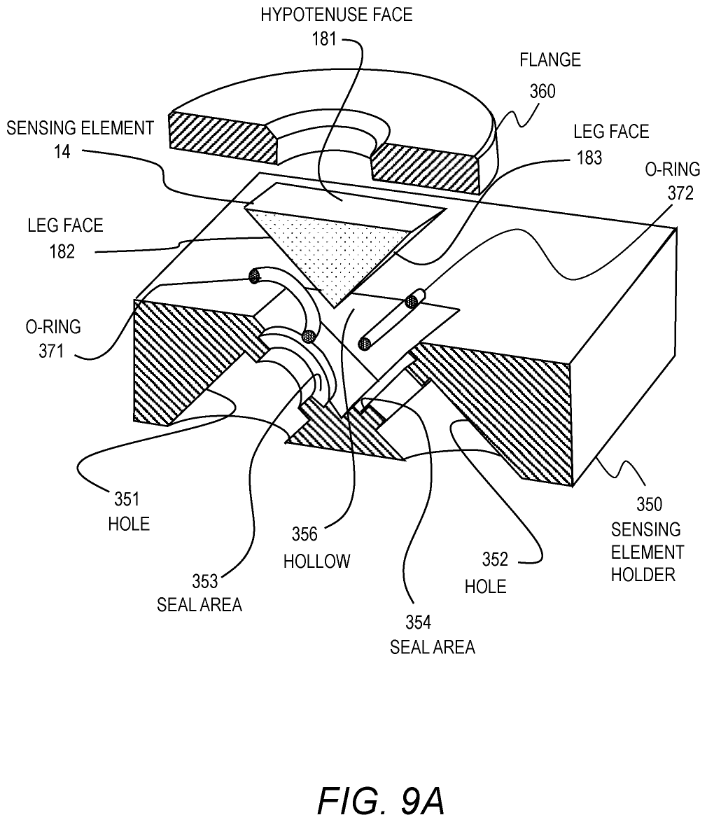

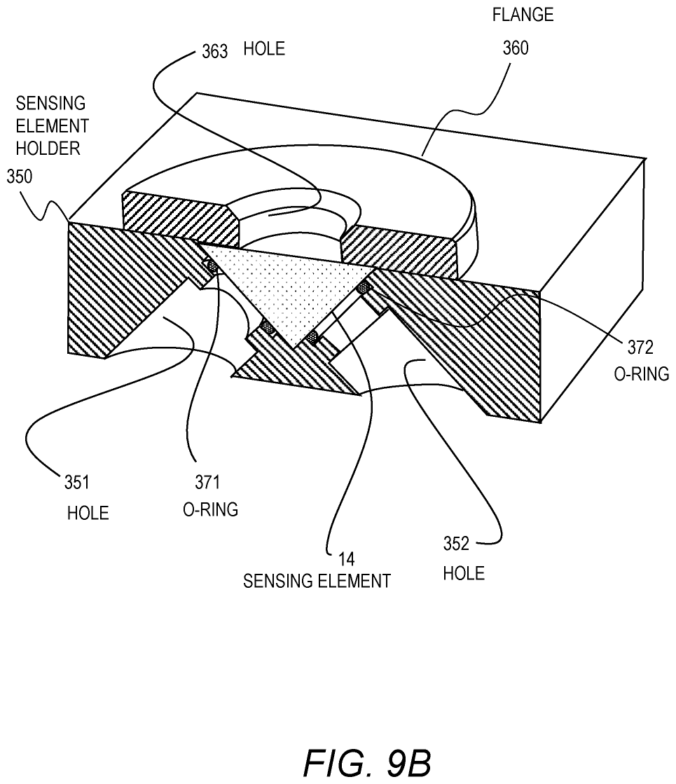

Next, fixing the sensing element 14 with the flange 360 and the sensing element holder 350 is described more specifically. FIG. 9A is an exploded perspective diagram illustrating cross-sections of the flange 360, the sensing element 14, and the sensing element holder 350. Hydrogen gas of the target substance is provided on the upper side of FIG. 9A and the ambient air is on the lower side. The light from the light source 11 travels through the hole 351 and enters the sensing element 14. The light reflected off the sensing element 14 exits through the hole 352.

The O-ring 371 is placed on the seal area 353 provided in the hollow 356 of the sensing element holder 350. The O-ring 372 is placed on the seal area 354 provided in the hollow 356 of the sensing element holder 350. The inner end of the seal area 353 defines the opening of the hole 351 and the inner end of the seal area 354 defines the opening of the hole 352.

The sensing element 14 including a prism 146 is placed in the hollow 356. The leg face 182 faces the O-ring 371 and the hole 351 and is in contact with the O-ring 371. The leg face 183 faces the O-ring 372 and the hole 352 and is in contact with the O-ring 372. The hypotenuse face 181 is located in the opening of the hollow 356 (on the opposite side of the bottom of the hollow 356). The flange 360 is attached to the sensing element holder 350 to be in contact with a part of the hypotenuse face 181.

When the O-rings 371 and 372, the sensing element 14, and the flange 360 are merely placed at predetermined positions on the sensing element holder 350, the hypotenuse face 181 of the sensing element 14 is located higher than the sensing element holder 350 and the O-rings 371 and 372 have not been elastically deformed yet. Fastening the flange 360 to the sensing element holder 350 with screws 362 as illustrated in FIG. 7D compresses and elastically deforms the O-rings 371 and 372 between the sensing element 14 and the sensing element holder 350, so that the gaps therebetween are sealed.

FIG. 9B illustrates a state where the flange 360 is pressed and fastened to the sensing element holder 350 with screws 361 (not shown in FIG. 9B). The sensing element 14 is pressed by the flange 360 and lowered to the inner faces (the faces oriented toward the test object) of the hollow 356 of the sensing element holder 350. The leg faces 182 and 183 are in contact with the top faces of the steps provided around the O-rings 371 and 372. In this state, the O-rings 371 and 372 are compressed in appropriate amounts.

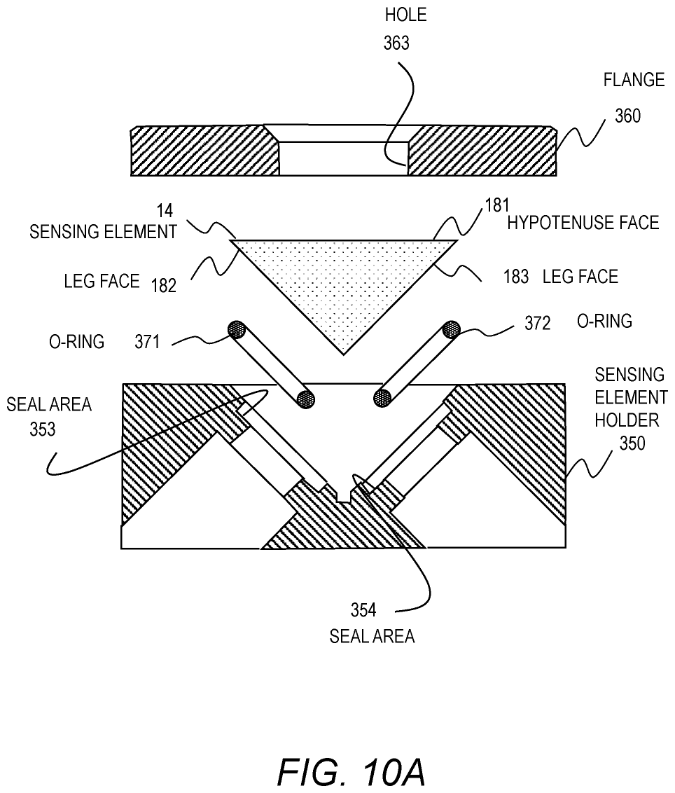

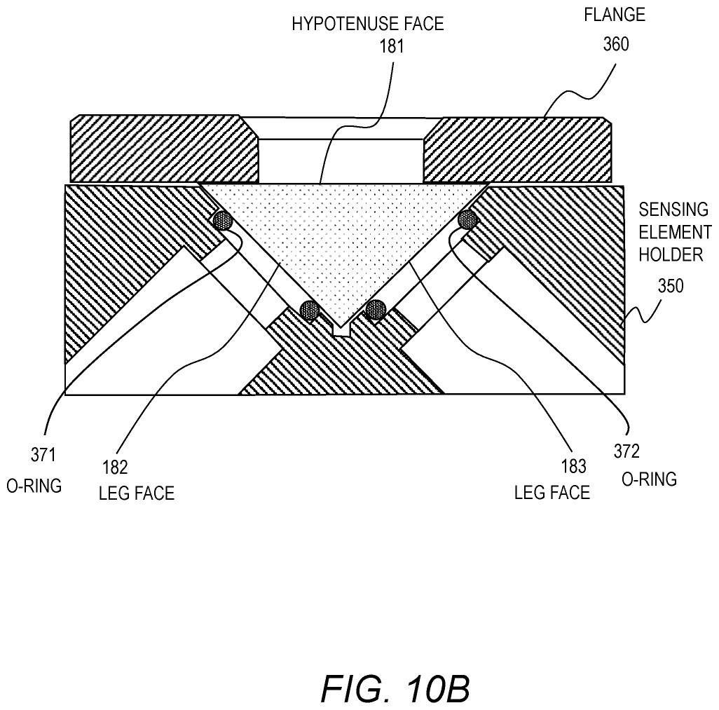

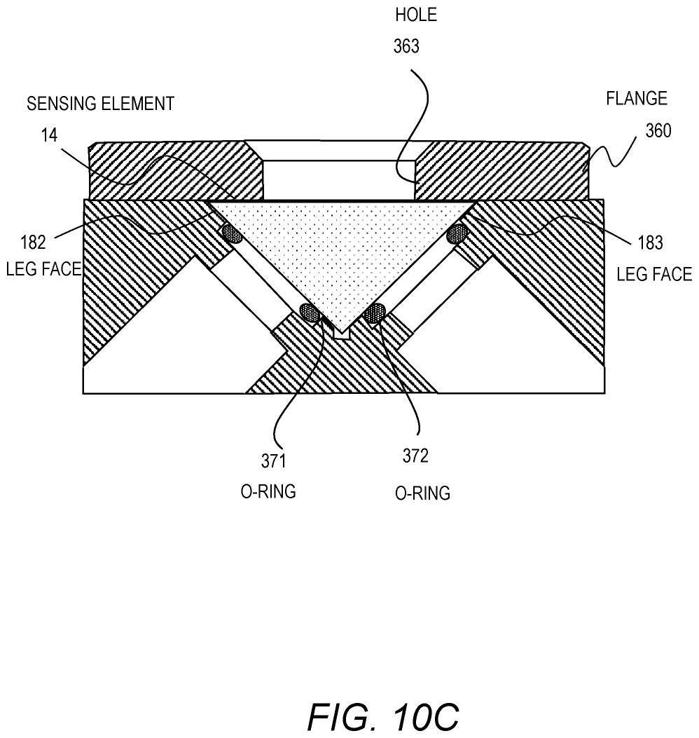

FIG. 10A is a cross-sectional diagram of the flange 360, the sensing element 14, the O-rings 371 and 372, and the sensing element holder 350 before they are assembled and corresponds to FIG. 9A. The upper region of FIG. 10A is a region where hydrogen gas is to be provided and the lower region is a region where the optical system is disposed.

FIG. 10B is a cross-sectional diagram of a state where the O-rings 371 and 372, the sensing element 14, and the flange 360 are mounted on the sensing element holder 350 but not yet pressed and fastened with screws 361 (not shown in FIG. 10B). The O-rings 371 and 372 are placed on the seal areas 353 and 354, respectively. The sensing element 14 is placed on the O-rings 371 and 372. The leg faces 182 and 183 are in contact with the O-rings 371 and 372, respectively. The O-rings 371 and 372 are not compressed; the hypotenuse face 181 of the sensing element 14 is located higher than the top face of the sensing element holder 350. The flange 360 is placed on the hypotenuse face 181 in such a manner that a part of the hypotenuse face 181 is exposed through a hole 363 of the flange 360.

FIG. 10C is a cross-sectional diagram of a state where the flange 360 is pressed and fastened to the sensing element holder 350 with screws 361 (not shown in FIG. 10C) and corresponds to FIG. 9B. The sensing element 14 is pressed by the flange 360 and is lowered to the inner faces (the faces oriented toward the test object) of the hollow 356 of the sensing element holder 350. The leg faces 182 and 183 are in contact with the top faces of the steps provided around the O-rings 371 and 372. In this state, the O-rings 371 and 372 are compressed between the leg faces 182 and 183 and the inner faces of the hollow 356 to seal the gaps between the leg faces 182 and 183 and the inner faces of the hollow 356.

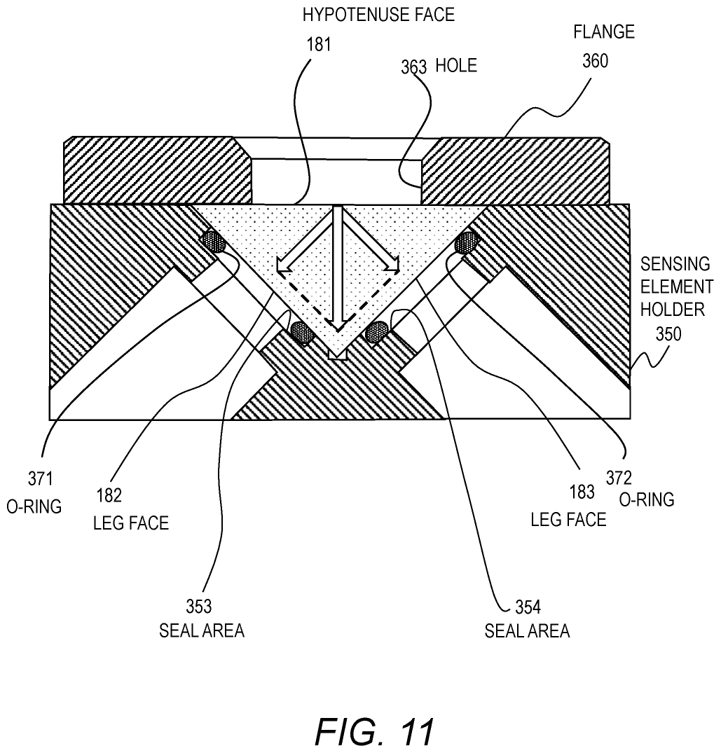

FIG. 11 is a diagram illustrating the region between the prism 146 of the sensing element 14 and the sensing element holder 350 to be sealed by the O-rings 371 and 372. FIG. 11 illustrates a state after the flange 360 is fastened to the sensing element holder 350.

The hypotenuse face 181 of the sensing element 14 is pushed by the flange 360 vertically downward in FIG. 11. The seal areas of the sensing element 14 are parts of the leg faces 182 and 183 that are inclined with respect to the hypotenuse face 181 by 45°; the component forces of the pushing force in two directions compress the O-rings 371 and 372. As a result, the seal areas of the leg faces 182 and 183 and the seal areas 353 and 354 of the sensing element holder 350 are sealed together.

In the common usage of an O-ring, the pressing force is applied in the direction to compress the O-ring; however, this configuration example applies a force in one direction different from the directions to compress the O-rings 371 and 372 to simultaneously compress the O-rings 371 and 372 with its component forces to achieve seals.

Next, the region of the layered film 140 on the hypotenuse face 181 of the prism 146 is described. If the layered film 140 is deposited on the right-angle prism without any consideration, the flange 360 contacts the layered film 140 in fixing the sensing element 14. If the layered film 140 contacts the flange 360 in some region, the film may be damaged in the contact region. Damage only at a single point may expand from there to affect the entire layered film 140. An embodiment of this specification forms a layered film 140 to cover the region that contributes to measurement of hydrogen gas while avoiding the region to be contacted by the flange 360.

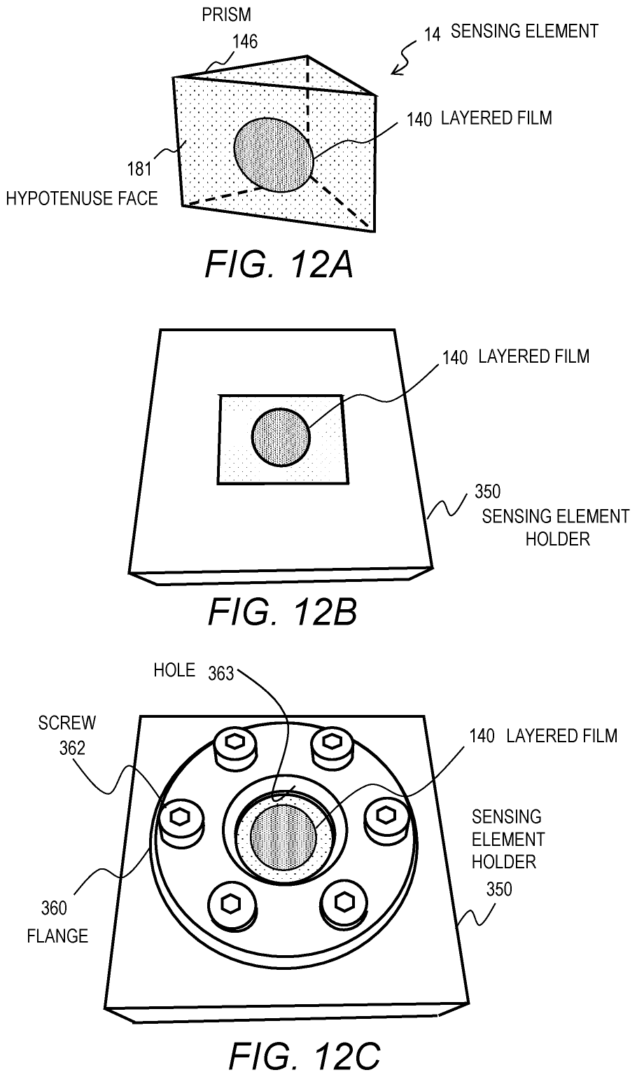

FIG. 12A illustrates an example of the region of the layered film 140 provided on the hypotenuse face 181 of the prism 146. Although the layered film 140 in FIG. 12A has a circular shape, the shape of the layered film 140 is not limited to a specific one. The layered film 140 can be deposited directly on the hypotenuse face 181 of the prism 146. Alternatively, the layered film 140 can be deposited on a glass plate and the opposite face of the glass plate can be coupled to the hypotenuse face 181 of the prism 146 with optical coupling oil. The layered film 140 can be usually formed by sputtering. To form the layered film 140 on a part of the hypotenuse face 181 of the prism 146, a metal mask having an opening in the region corresponding to the part of the hypotenuse face 181 of the prism 146 where to form the layered film can be used in holding the prism 146 for film formation.

FIG. 12B illustrates a state where the sensing element 14 in FIG. 12A is attached on a sensing element holder 350. FIG. 12C illustrates a state where a flange 360 for pressing and fixing the sensing element 14 is screwed to the sensing element holder 350.

As illustrated in FIG. 12C, the entire layered film 140 is located within the central hole 363 of the flange 360. Since the layered film 140 is not in contact with the flange 360, the layered film 140 is not damaged by the flange 360, preventing the layered film 140 from peeling off from the damaged point.

### Embodiment 2

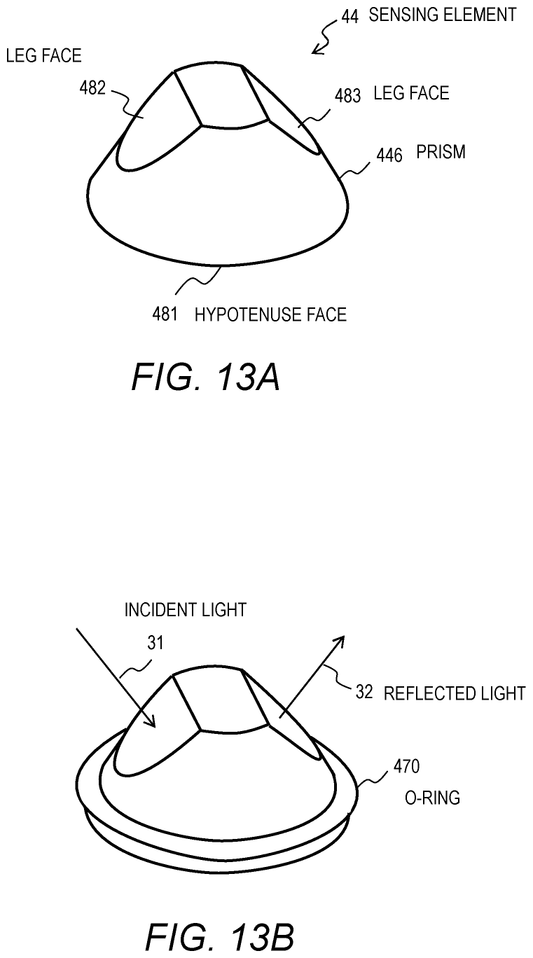

Another structural example of a prism is described. FIG. 13A illustrates a structural example of a sensing element 44. The sensing element 44 has a shape such that leg faces are formed on a conical frustum. Specifically, a hypotenuse face 481 is one of the bases of the conical frustum and leg faces 482 and 483 are two flat inclined faces formed on the side face of the conical frustum at an angle of 45° with respect to the hypotenuse face 481 and being orthogonal to each other. The layered film for measuring the hydrogen gas is provided on the hypotenuse face 481. The prism 446 of the sensing element 44 in FIG. 13A is a right-angle prism.

FIG. 13B illustrates the sensing element 44 and an O-ring 470 attached around the side face of the sensing element 44. The O-ring 470 seals the gap between the side face of the conical frustum and the confining wall. The O-ring 470 has a toric shape and its cross-section is circular. The inner diameter of the O-ring 470 is smaller than the diameter of the hypotenuse face 481. In the configuration example in FIG. 13B, the O-ring 470 is disposed outside the leg faces 482 and 483 and between the hypotenuse face 481 and the leg faces 482 and 483. The cross-section of the O-ring 470 does not need to be circular. The shape of the O-ring 470 accords with the outer end of the side face of the prism 446 of the sensing element 44. Accordingly, if the outer end of the side face of the sensing element 44 is oval, the O-ring is also an oval ring.

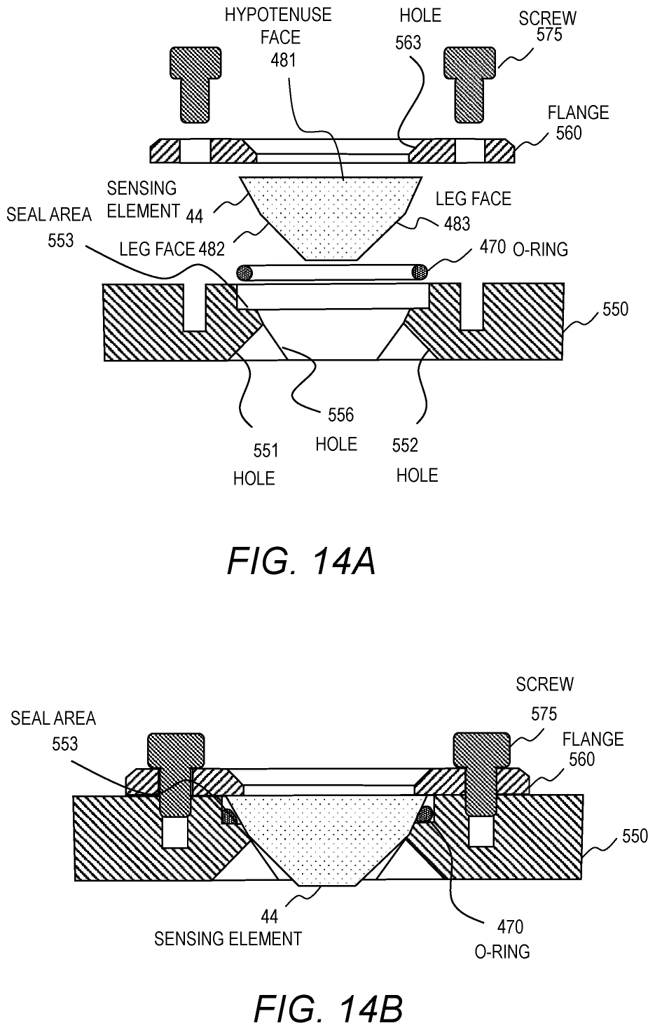

FIGS. 14A and 14B are cross-sectional diagrams for illustrating a configuration example in which a sensing element 44 including a conical frustum prism is fixed to be used as a part of a confining wall. FIG. 14A is a state before the sensing element 44 and a flange 560 are mounted on a sensing element holder 550. The sensing element 44 is pressed and fixed between the flange 560 and the sensing element holder 550 having a plate-like shape. The sensing element holder 550 corresponds to the aforementioned sensing element holder 350.

The flange 560 is fastened to the sensing element holder 550 with a plurality of screws 575. The screws 575 extend through holes of the flange 560 to be inserted into screw holes of the sensing element holder 550. The screw holes are not through-holes. In FIGS. 14A and 14B, one of the plurality of screws is provided with a reference sign 575 by way of example. The flange 560 can have a disc-like shape having a hole 563 at the center, like the flange 360. Hydrogen gas of the target substance is provided on the upper side of FIG. 14A and the ambient air is on the lower side. The light from the light source 11 travels through a hole 551 and enters the sensing element 44. The light reflected off the sensing element 44 exits through a hole 552.

An O-ring 470 is placed on a seal area 553 on a step provided inside a tapered hole 556 of the sensing element holder 550. The seal area 553 is facing the flange 560 and formed annularly on the inner face of the hole 556. The O-ring 470 is placed on the seal area 553. The inner end of the seal area 553 defines the opening of a deeper space of the hole 556 for accommodating the leg faces 482 and 483.

In the configuration example of FIGS. 14A and 14B, the hole 556 has two spaces. The space in a shallower depth that is closer to the flange 560 (the upper space in FIG. 14A) has a cylindrical shape having a uniform width. The deeper space (the lower space in FIG. 14A) has a shape like a conical frustum whose width gradually decreases from the region closer to the flange 560. The inner face of the hole 556 defining the conical frustum space is tapered and substantially identical to the tapered surface of the side of the conical frustum prism 446.

The sensing element 44 including the prism 446 is placed in the hole 556. The leg face 482 faces the hole 551. The leg face 483 faces the hole 552. The hypotenuse face 481 is located on the opposite side of the holes 551 and 552. The flange 560 is mounted on the sensing element holder 560 in such a manner that the flange 560 is in contact with a part of the hypotenuse face 481. The layered film of the sensing element 44 is exposed from the hole 563 of the flange 560.

When the O-ring 470, the sensing element 44, and the flange 560 are merely placed at predetermined positions on the sensing element holder 550, the hypotenuse face 481 of the sensing element 44 is located higher than the sensing element holder 550 and the O-ring 470 has not been compressed yet.

FIG. 14B illustrates a state where the flange 560 is fastened to the sensing element holder 550 with the screws 575. The side face of the prism 446 fits the opening of the deeper (lower in FIG. 14A) space of the hole 556 or the opening between the space in the shallower depth and the deeper space. The O-ring 470 is interposed between the side face of the prism 446 and the inner face of the hole 556 of the sensing element holder 550, surrounding the opening. As a result of fastening the flange 560 to the sensing element holder 550 with the screws 575, the O-ring 470 is compressed between the side face of the prism 446 and the inner face of the hole 556 of the sensing element holder 550 to seal the gap therebetween.

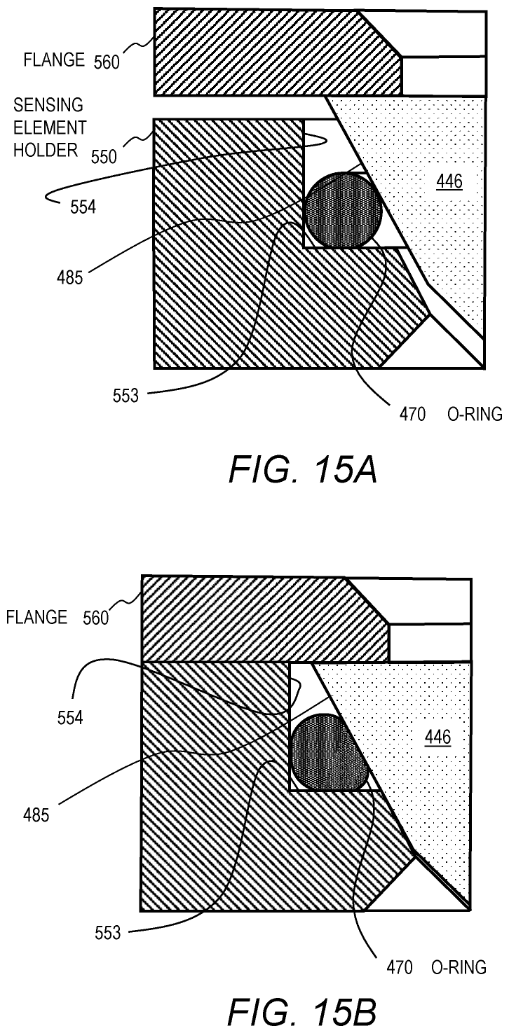

FIG. 15A illustrates a state of the O-ring 470 when the O-ring 470, the sensing element 44, and the flange 560 are placed in this order onto the sensing element holder 550 but the flange 560 has not yet been fastened with the screws 575. The O-ring 470 is surrounded by faces 553 and 554 defining the hole 556 of the sensing element holder 550 and a part 485 of the side face of the prism 446. As described above, the O-ring 470 is placed on the seal area 553 and thereafter, the prism 446 is inserted into the hole 556. The flange 560 is placed on the prism 446. The O-ring 470 has not been compressed yet.

FIG. 15B illustrates a state where the flange 560 is fastened to the sensing element holder 550 with the screws 575. The O-ring 470 is in contact with the seal areas 553, 554, and 485 and compressed by being pressed against these. In this state, the O-ring 470 functions as a seal.

### Embodiment 3

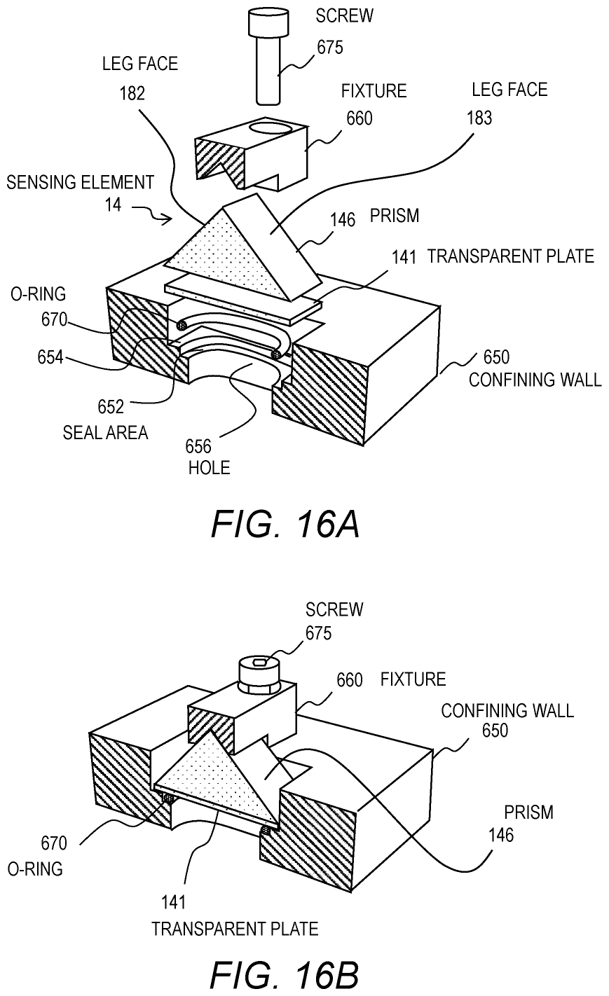

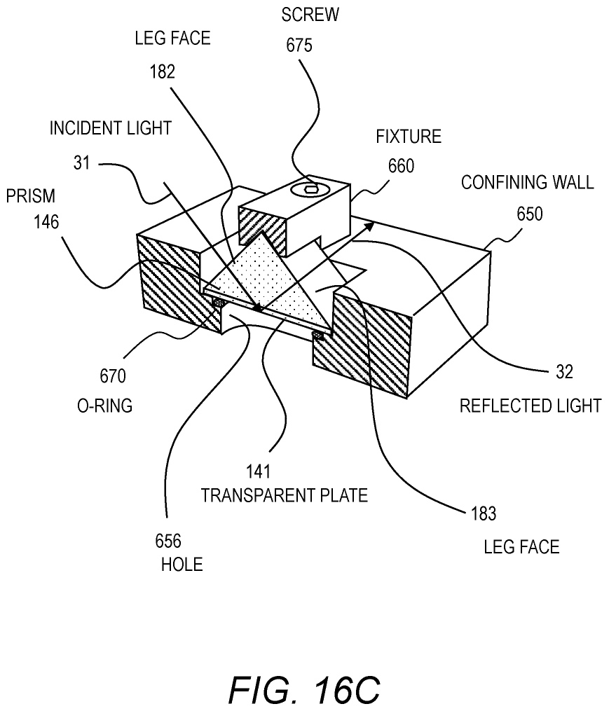

Another embodiment of the gastight structure utilizing a sensing element including a prism is described. The prism has the same structure as the one described in Embodiment 1. FIG. 16A is an exploded perspective diagram illustrating cross-sections of the components of the gastight structure in this embodiment. The gastight structure includes a fixture 660, a prism 146 and a transparent plate 141 of a sensing element 14, a confining wall 650, and an O-ring 670. Hydrogen gas of the target substance is provided on the lower side of FIG. 16A and the ambient air is on the upper side. Although the sensing element 14 in the following description includes a transparent plate 141, the transparent plate 141 is optional. In another example, the layered film 140 can be deposited directly on the hypotenuse face of the prism.

FIG. 16A illustrates a half of the gastight structure. Accordingly, another structure identical to the structure in FIG. 16A is symmetrically located on the opposite side with respect to the cross-section as the plane of symmetry. That is to say, the prism 146 can be fixed to the confining wall 650 by a single fixture 660. The fixture 660 can be two or more separate fixtures.

The O-ring 670 is placed on a seal area 652 on a step provided in a hole 656 of the confining wall 650. The height of the step between the seal area 652 and a support area 654 is smaller than the cross-section diameter of the O-ring 670. The difference of the cross-section diameter from the height of the step is in the range where the amount of compression of the O-ring 670 can provide effective sealing characteristics.

The sensing element 14 including the prism 146 and the transparent plate 141 is placed on the O-ring 670 within the hole 656 of the confining wall 650. The transparent plate 141 is in contact with the O-ring 670. The leg faces 182 and 183 are oriented toward the opposite side of the seal area 652 of the confining wall 650 or the ambient air. A part of the hole 656 becomes a part of a gas channel.

The fixture 660 is placed on the prism 146 and the confining wall 650 in such a manner that the fixture 660 covers a part of the prism 146, specifically, parts of the leg faces 182 and 183. The fixture 660 has a shape that fits the corner between the leg faces 182 and 183 of the prism 146 in the part opposed to the prism 146 and the surface of the part is in contact with the parts of the leg faces 182 and 183. Further, a screw 675 extends through a hole in the fixture 660 to be inserted into a screw hole of the confining wall 650.

FIG. 16B illustrates a state before the fixture 660 is fastened with the screw 675. When the O-ring 670, the sensing element 14, and the fixture 660 are merely placed at predetermined positions on the confining wall 650, the O-ring 670 has not been compressed yet. Fastening the fixture 660 to the confining wall 650 with a screw 675 makes the O-ring 670 compressed between the sensing element 14 and the confining wall 650 to seal the gap therebetween.

FIG. 16C illustrates a state where the fixture 660 is pressed and fastened to the confining wall 650 with the screw 675. The transparent substrate including the prism 146 and the transparent plate 141 is fixed at a predetermined position as illustrated in FIG. 16C. The transparent substrate including the prism 146 and the transparent plate 141 is pressed against the O-ring 670 by the fixture 660. In this state, the O-ring 670 is compressed between the transparent plate 141 of the transparent substrate and the seal area 652. When the transparent plate 141 comes in contact with the support area 654 and is fixed at the predetermined position, the O-ring 670 is compressed in an appropriate amount, so that the gap between the inner face of the hole 656 and the sensing element 14 is sealed.

The optical path of the incident light 31 on the leg face 182 and the reflected light 32 that goes out from the leg face 183 passes through the space between the fixture 660 and the confining wall 650. As noted from this description, the gastight structure is designed so that the optical path of the light for measurement will not be blocked by a component. In FIG. 16C, the space of the hole 656 lower than the transparent plate 141 is a gastight space where hydrogen gas is to be provided. The gas-tightness is maintained by the O-ring 670. The layered film 140 on the transparent plate 141 is exposed to the hydrogen gas in the region surrounded by the O-ring 670 in the hole 656.

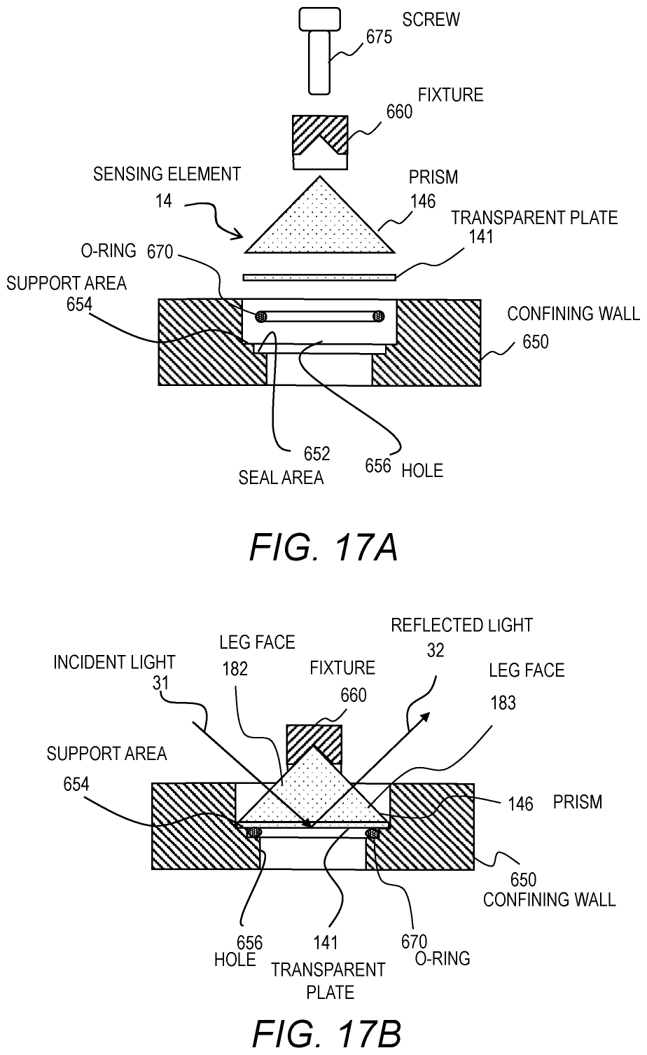

FIG. 17A is a cross-sectional diagram of the screw 675, the fixture 660, the prism 146, the transparent plate 141, the O-ring 670, and the confining wall 650 before being assembled. The lower region of FIG. 17A is a region where hydrogen gas is to be provided and the upper region is a region where the optical system is disposed.

The hole 656 of the confining wall 650 includes three spaces different in shape from the top toward the bottom of FIG. 17A. The uppermost space or the space closest to the fixture 660 accommodates the sensing element 14 (a part thereof) including the prism 146 and the transparent plate 141. As illustrated in FIGS. 16A and 17A, the space for accommodating the sensing element 14 has a shape of substantially a cuboid.

The second space accommodates the O-ring 670 and has a shape like a rounded rectangular column. In this example, this space has a rounded rectangular cross-section to provide a larger opening so that a quadrangular film surface of the sensing element can contact the test object as much as possible and the O-ring 670 is disposed along its inner wall. However, the cross-section of this space can be circular or oval. When viewed from the side where the fixture 660 is to be placed, this space is located inside the space for accommodating the sensing element 14. The lowermost space has a shape like a rounded rectangular column and is a part of a gas channel 310. The opening of this space has a shape similar to the shape of the opening of the space for accommodating the O-ring 670. When viewed from the side where the fixture 660 is to be placed, this space is located inside the space for accommodating the O-ring 670. The shapes of the spaces included in the hole 656 are not limited to the above-described ones.

The O-ring 670 is placed on the seal area 652. The inner face of the hole 656 is provided with a support area 654 in addition to the seal area 652. As will be described later, the support area 654 supports the sensing element 14. These areas 652 and 654 are oriented toward the transparent plate 141 or the prism 146. In FIG. 17A, the areas 652 and 654 are oriented upward. The seal area 652 is the top face of the lower step formed on the inner face of the hole 656 and the support area 654 is the top face of the upper step. The two areas 652 and 654 have annular shapes when viewed from the side where the prism is to be placed and the inner diameter of the support area 654 can be equal to or larger than the outer diameter of the seal area 652.

After the O-ring 670 is placed on the seal area 652, the sensing element 14 including the transparent plate 141 and the prism 146 is placed on the O-ring 670. A main face of the transparent plate 141 faces the O-ring 670 and comes in contact with the O-ring 670. When the assembly is viewed in the vertical direction in FIGS. 17A and 17B (the direction of pressing), the outer end of the O-ring 670 is located within the main face of the transparent plate 141. The main face of the transparent plate 141 is away from the support area 654. The layered film 140 is provided on the surface of the transparent plate 141 facing the O-ring 670.

Subsequently, the fixture 660 is placed on the prism 146 and the confining wall 650 in such a manner that the fixture 660 covers parts of the leg faces 182 and 183 of the prism 146. The screw 675 is inserted through the mounting hole of the fixture 660 to be inserted into the screw hole of the confining wall 650. The screw 675 is tightened so that the transparent substrate including the prism 146 and the transparent plate 141 goes down in the hole 656 to compress the O-ring 670.

FIG. 17B illustrates a state where the fixture 660 is fastened to the confining wall 650 with the screw 675. The sensing element 14 including the prism 146 and the transparent plate 141 is pressed against the O-ring 670 and the support area 654 by the fixture 660. The sensing element 14 and the O-ring 670 cover the opening of the hole 656 of the confining wall 650.

The sensing element 14 is pressed and fixed between the fixture 660 and the confining wall 650. In this state, the transparent plate 141 is in contact with the support area 654. The O-ring 670 is compressed between the seal area 652 and the transparent plate 141 to seal the gap between the transparent plate 141 and the seal area 652.

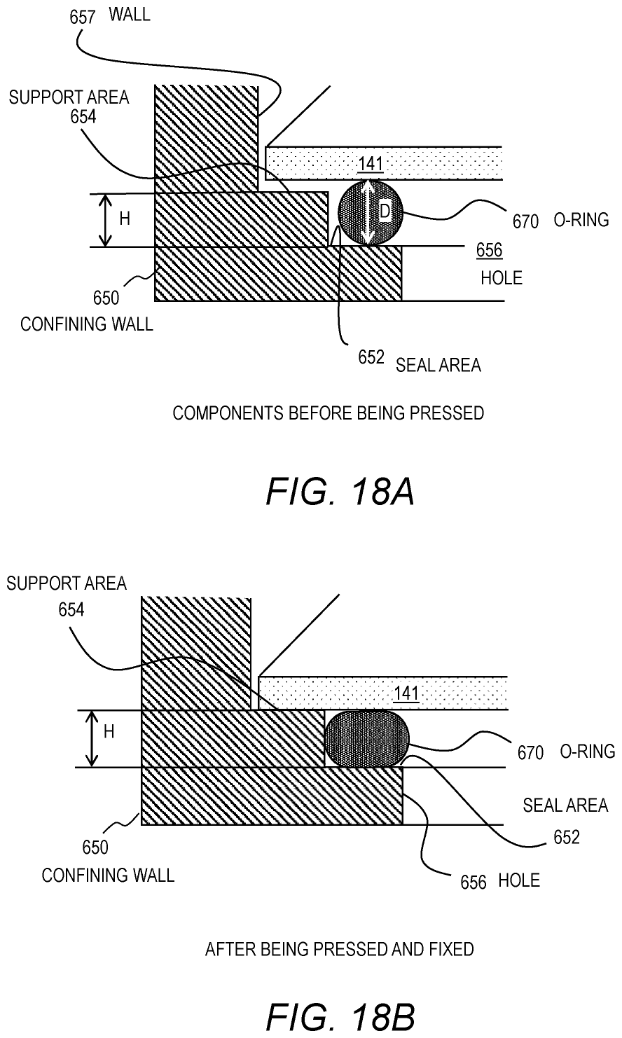

FIGS. 18A and 18B are cross-sectional diagrams for illustrating the sealing structure by the O-ring 670. The state in FIG. 18A corresponds to the state in FIG. 16B. The state in FIG. 18B corresponds to the state in FIG. 16C. Specifically, in FIG. 18A, the O-ring 670 and the sensing element 14 are placed in the hole 656 of the confining wall 650 but the sensing element 14 is not pressed by the fixture 660. The transparent plate 141 is on the O-ring 670 and in contact with the O-ring 670. The transparent plate 141 is away from the support area 654.

The O-ring 670 is placed on the seal area 652. In the example in FIG. 18A, the O-ring 670 has a circular cross-section and has a cross-section diameter D. The cross-section diameter D is larger than the step height H between the two areas 652 and 654. The difference between the cross-section diameter D and the step height H is the squeeze of the O-ring 670. The transparent plate 141 is inserted into the hole 656 in such a manner that the end face of the transparent plate 141 slips along the wall 657, which is a part of the inner face of the hole 656. The wall 657 functions as a guide for the transparent substrate including the prism 146 to get into position.

FIG. 18B illustrates a state of the transparent plate 141 of the sensing element 14 and the O-ring 670 after being pressed and fixed by the fixture 660 and the screw 675. The O-ring 670 on the seal area 652 is compressed by the transparent plate 141. The end region of the main face of the transparent plate 141 is in contact with the support area 654. The support area 654 supports the sensing element 14 together with the O-ring 670. The O-ring 670 is under an appropriate squeeze to be a secure seal while keeping the surface of the layered film 140 in position (at a proper level).

Next, the region of the transparent plate 141 or the hypotenuse face 181 of the prism 146 to be provided with the layered film 140 is described. If the layered film 140 is deposited on the transparent plate 141 or the prism 146 without any consideration, the O-ring 670 comes in contact with the layered film 140. If the layered film 140 has a region in contact with the O-ring 670, the film may be damaged in the contact region. Damage only at a single point may expand from there to affect the entire layered film 140.

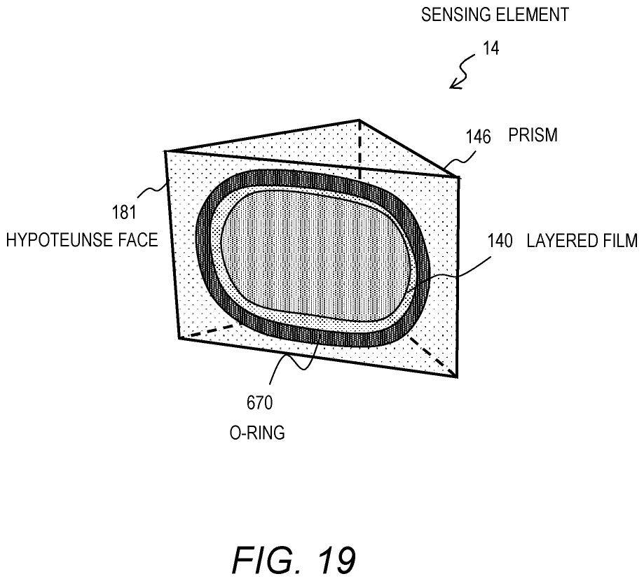

FIG. 19 illustrates an example of the region of the layered film 140 provided on the hypotenuse face 181 of a prism 146. Although the layered film 140 in FIG. 19 has a rounded rectangular shape, the shape of the layered film 140 is not limited to a specific one. The layered film 140 can be deposited directly on the hypotenuse face 181 of the prism 146. Alternatively, the layered film 140 can be deposited on a glass plate and the opposite face of the glass plate can be coupled to the hypotenuse face 181 of the prism 148 with optical coupling oil.

As illustrated in FIG. 19, the entire layered film 140 is in the central hole of the O-ring 670. The layered film 140 is not in contact with the O-ring 670. The configuration of the layered film 140 to be employed should satisfy at least the conditions that the layered film 140 is provided in the region that contributes to measurement by being irradiated with measurement light and not provided in the region required for sealing. Not providing the layered film 140 in the region to be contacted by the O-ring 670 saves the layered film 140 from damage, attaining a stable and highly reliable element.

### Embodiment 4

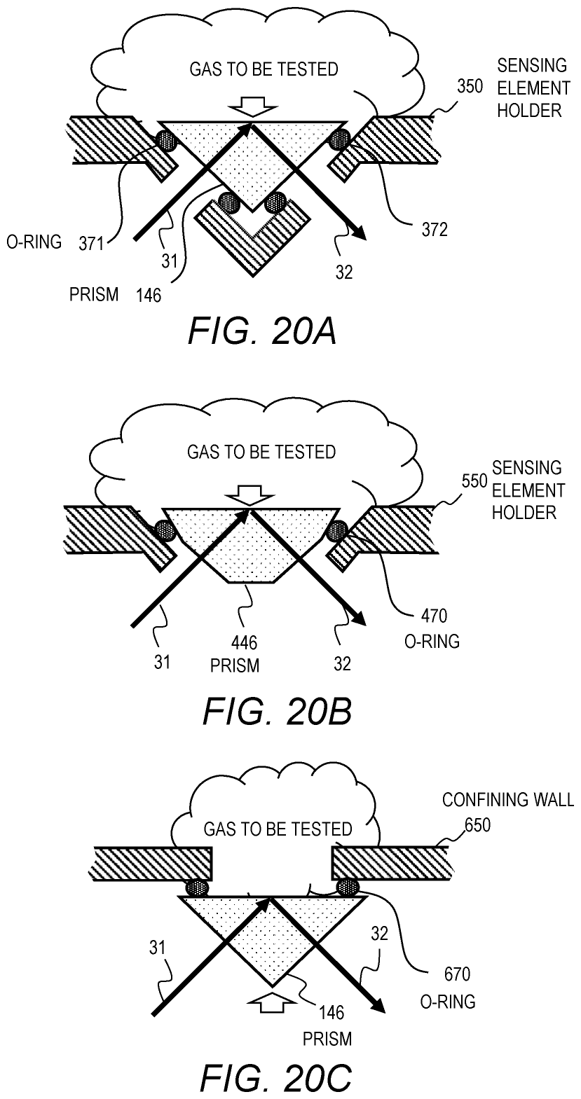

FIGS. 20A to 20C schematically illustrate the gastight structures in the foregoing embodiments. FIG. 20A schematically illustrates the gastight structure in Embodiment 1; FIG. 20B schematically illustrates the gastight structure in Embodiment 2; and FIG. 20C schematically illustrates the gastight structure in Embodiment 3. In FIGS. 20A, 20B, and 20C, the hollow arrows represent the direction of pressing the prism. The prism is pressed to compress the O-ring.

As described above, the transparent substrates of the sensing elements in the embodiments of this specification include a prism. For this reason, these transparent substrates exhibit a high mechanical strength, compared to a transparent substrate made of a thin glass plate only.

As described above, the transparent substrate of a sensing element can consist of a prism or a prism and a transparent plate. When a large pressure difference between the hydrogen-containing gas to be tested and the ambient air is applied to the transparent plate of a thin glass plate, the transparent plate may be broken. Accordingly, an embodiment of this specification deposits the layered film of a gas sensing film directly on the hypotenuse face of the prism and uses the prism of a mass of glass as a structural member for a part of a gastight confining wall without using a thin glass plate. This configuration reduces the possibility of a break of the sensing element. On the other hand, including a transparent plate facilitates formation of the gas sensing film.

The embodiments of this disclosure illustrated in FIGS. 20A, 20B, and 20C place a sensing element including a prism at the boundary between the space for containing the gas to be tested and the external, where a pressure difference exists, and use the structure of the sensing element as a part of a gastight confining wall. The embodiments place an O-ring between the surface of the transparent substrate on which the layered film is provided and the confining wall to achieve a seal. The presence of the O-ring maintains the gas-tightness and prevents the gas to be tested from leaking to the external or the ambient air from flowing in the measurement space.

The embodiments of this disclosure fix the sensing element including a prism at the position where the O-ring is compressed in the amount that provides effective sealing characteristics. Even if the pressure difference between inside and outside the confining wall acts on the prism, the amount of compression of the O-ring does not change as much as the amount of compression affects the seal. Accordingly, sufficient sealing characteristics are ensured in either case where the pressure of the gas to be tested is higher or lower than the pressure of the ambient air.

The embodiments illustrated in FIGS. 20A and 20B press the prism 146 or 446 in the direction away from the gas channel 310 containing the gas to be tested. When the gas to be tested is pressurized or at a higher pressure than the ambient air, the pressure difference acts on the O-rings 371 and 372 or the O-ring 470 in the direction to increase their deformation. Hence, the O-rings 371 and 372 or the O-ring 470 can securely prevent leakage of the gas to be tested. In the case of employing a transparent plate 141 in these embodiments, optical coupling oil may be mixed in the atmosphere of the gas to be tested. Directly depositing the layered film 140 of a hydrogen sensing film on the prism 146 or 446 can avoid contamination by the optical coupling oil.

The embodiment illustrated in FIG. 20C presses the prism 146 in the direction toward the gas channel 310 containing the gas to be tested. When the gas is depressurized or at a lower pressure than the ambient air, the pressure difference acts on the O-ring 670 to increase its deformation. Hence, the O-ring 670 can securely prevent leakage of the gas. In the case where the sensing element includes a transparent plate 141 and the O-ring 670 is pressed by the transparent plate 141, the optical coupling oil between the transparent plate 141 and the prism 146 is located outside the space containing the gas to be tested and therefore, contamination of the gas to be tested can be avoided. The layered film 140 can be deposited directly on the hypotenuse face 181 of the prism 146.

The foregoing embodiments seal the gap between a sensing element and a confining component with an O-ring of an example of an elastic sealing component. In another embodiment, a part or all of the sealing structure can be made of an adhesive. Specifically, the elastic sealing component can be an elastic member having a surface region made of a substance having viscosity or adhesiveness. Then, the sealing characteristics are enforced. The cross-sectional shape of the region for mounting the sensing element is not limited to those described in the embodiments but can be a step structure that can stabilize the position and orientation of the prism and provide a uniform squeeze to the O-ring.

Although the foregoing embodiments have described optical hydrogen gas sensors as examples of optical chemical sensors, the optical chemical sensor of this disclosure is not limited to the hydrogen gas sensor. The target to be detected by the optical chemical sensor is the concentration of the target substance and the gastight structure of this disclosure that utilizes the sensing element is applicable to various sensors such as optical ion sensors for detecting pH of a liquid, optical gas sensors for detecting a gas of a kind different from hydrogen gas, and optical biosensors for detecting DNA or an enzyme in a liquid. As noted from this description, the object to be tested can be fluid including gas and liquid. The gastight structure of this disclosure can exhibit the same effects as described in the foregoing embodiments in the cases of application to the various optical chemical sensors listed above.

As described above, the optical chemical sensors in the embodiments of this disclosure illuminate the sensing film deposited on a transparent substrate with measurement light incident on the underside of the transparent substrate and measure the target substance with the reflected light. The transparent substrate includes a prism and the sensing film is deposited on the surface of the transparent substrate. The sensing film is exposed to the test object and the face of the transparent substrate through which the measurement light passes through is exposed to the external environment. The transparent substrate including a prism functions as a part of the confining wall between the test object and the external environment. The gap between the transparent substrate including a prism and the other part of the confining wall is sealed with a sealing structure.

In the measurement utilizing an oblique-incidence on the underside of a transparent substrate, a prism is necessary to eliminate direct reflection off the transparent substrate. Using a transparent substrate including such a prism as a part of a confining wall ensures sufficient mechanical strength that is not achieved by a thin glass substrate alone. The transparent substrate further provides functionality such as confinement, optical transparency, and elimination of direct reflection off its underside, contributing to achievement of a compact and low-cost device.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. An optical sensor device comprising:
a light source;
a sensing element;
a photodetector;
a fixture; and
an elastic sealing component,
wherein the sensing element includes:
a prism including a hypotenuse face and two leg faces; and
a sensing film on the hypotenuse face, the sensing film being configured to sense a target substance,
wherein the sensing film is exposed to a gastight space to include the target substance,
wherein a confining wall confining the gastight space to include the target substance has an opening and the opening is covered with the sensing element,
wherein the elastic sealing component is located between the sensing element and the opening,
wherein the sensing element is fixed by being pressed by the fixture in such a strength that the elastic sealing component is elastically deformed,
wherein the light source and the photodetector are located outside the gastight space to include the target substance,
wherein light from the light source is configured to pass through one of the two leg faces and hit the sensing film,
wherein light reflected off the sensing film is configured to go out through the other one of the two leg faces, and
wherein the photodetector is configured to detect light that is reflected off the sensing film and comes out through the other one of the two leg faces.

2. The optical sensor device according to claim 1,
wherein the opening is covered with the hypotenuse face, and
wherein the elastic sealing component is located between the hypotenuse face and the confining wall and surrounding the opening.

3. The optical sensor device according to claim 1,
wherein the prism further includes a conic side face,
wherein the opening is covered with the two leg faces and parts of the conic side face, and
wherein the elastic sealing component is located between the conic side face and the confining wall.

4. The optical sensor device according to claim 1,
wherein the opening is a first opening and the elastic sealing component is a first elastic sealing component,
wherein the optical sensor device further comprises a second elastic sealing component,
wherein the first opening is covered with a first leg face of the two leg faces,
wherein the first elastic sealing component is located between the first leg face and the confining wall and surrounding the first opening,
wherein the confining wall further has a second opening and the second opening is covered with a second leg face of the two leg faces,
wherein the second elastic sealing component is located between the second leg face and the confining wall and surrounding the second opening, and
wherein the prism is fixed by being pressed by the fixture in such a strength that the first elastic sealing component and the second elastic sealing component are elastically deformed.

5. The optical sensor device according to claim 2,
wherein the sensing film is deposited on a transparent plate,
wherein an oil is present between the transparent plate and the hypotenuse face,
wherein the elastic sealing component is located between the transparent plate and the confining wall, and
wherein the elastic sealing component is in contact with a main face of the transparent plate.

6. The optical sensor device according to claim 1, wherein the sensing film is deposited directly on the hypotenuse face of the prism.

7. The optical sensor device according to claim 1, wherein the entire sensing film is located in a region surrounded by the elastic sealing component.

8. The optical sensor device according to claim 1, wherein the elastic sealing component is an O-ring.

9. The optical sensor device according to claim 1, wherein the elastic sealing component has a surface including viscosity or adhesiveness.
